(19) United States
(12) Patent Application Publication
(10) Pub. No.: US 2007/0283277 A1
(43) Pub. Date: Dec. 6, 2007

(54) INFORMATION PROCESSING APPARATUS, THUMBNAIL MANAGEMENT APPARATUS, CONTENT PROCESSING METHOD, STORAGE MEDIUM, AND PROGRAM

(75) Inventor: Takeshi Hayakawa, Suginami-ku (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/691,387

(22) Filed: Mar. 26, 2007

(30) Foreign Application Priority Data
Mar. 31, 2006 (JP) 2006-100197

(51) Int. Cl. G06F 3/00

(52) U.S. Cl. 715/748

(57) ABSTRACT

A content processing method is executed by an information processing apparatus that carries out communications with a server apparatus that processes a request for viewing a registered thumbnail. The content processing method includes selecting, at the information processing apparatus, display control information specifying a manner of display of at least one attached thumbnail attached to display of at least one thumbnail; and issuing a registration request from the information processing apparatus to the server apparatus, the registration request requesting that the at least one attached thumbnail and the display control information be registered in association with management information of the at least one thumbnail.

### BACKGROUND OF THE INVENTION

1. Field of the Invention

The present invention relates to information processing apparatuses, information processing methods, and so forth for displaying thumbnails or the like.

2. Description of the Related Art

With the recent development of network technologies, various systems including information processing apparatuses and server apparatuses, used to store a large amount of electronic content (electronic document, image data, etc.) in storage devices so that the content can be reused, have been proposed.

In such a system, a function for allowing a user at a client to search for content and a function for allowing the user to download content are indispensable.

In the case of certain types of searching requests issued from a user at a client, it is requested to display representative images that allow recognition of individual pieces of content in addition to text.

An image used for such a purpose is referred to as a thumbnail or a thumbnail image.

A thumbnail refers to image data that can be handled by an information processing apparatus. Although a thumbnail usually refers to a reduced image for displaying a list of images, the ratio of reduction or the size of the image does not matter.

Functions that satisfy users' needs by displaying thumbnails in HTML documents on the Web are widely available, such as a function for displaying a list of images found by searching.

In such a function for displaying a thumbnail associated with registered content, there is a demand for highlighting a particular result for the user when a request for displaying a plurality of pieces of content is issued.

For example, attached information regarding content registered by a service provider, such as image information regarding advertisement, campaign, or discount, is presented to the user in association with selected product information. When such attached information is displayed, control is exercised to add highlighting so that the attached information is distinguished on a display at the client, for example, by decorating text that is displayed or arranging the order of display.

However, according to the related art for highlighting content, a dedicated HTML document must be generated for each piece of content. Thus, it has not been possible to flexibly deal with content that is displayed and content that is to be highlighted.

In another method of using thumbnails, for example, image data in the GIF format is processed to display an animation. In this case, however, animation pictures must be created for each piece of content. Thus, in addition to content that is displayed normally, image data used for displaying an animation must be created. This causes an increase in image resources that are to be managed by the system.

Furthermore, in the method of displaying thumbnails described above, display of a plurality of pieces of content is managed on the basis of an integrated data structure. Thus, it has often been pointed out that the versatility of individual pieces of content is very low, so that it is difficult to use content in a versatile manner.

### SUMMARY OF THE INVENTION

According to an aspect of the present invention, there is provided a content processing method for an information processing apparatus that carries out communications with a server apparatus that processes a request for viewing a registered thumbnail. The content processing method includes selecting, at the information processing apparatus, display control information specifying a manner of display of at least one attached thumbnail attached to display of at least one thumbnail; and issuing a registration request from the information processing apparatus to the server apparatus, the registration request requesting that the at least one attached thumbnail and the display control information be registered in association with management information of the at least one thumbnail.

Further features of the present invention will become apparent from the following description of exemplary embodiments with reference to the attached drawings.

### BRIEF DESCRIPTION OF THE DRAWINGS

FIG. 1 is a diagram showing an exemplary configuration of an information-content viewing system including an information processing apparatus and a server apparatus.

FIG. 2 is a block diagram showing exemplary configurations of a client personal computer (PC), a Hypertext Transfer Protocol (HTTP) server, and a Web-Application Server (WAS) shown in FIG. 1.

FIG. 3 is a block diagram showing an exemplary module configuration of the information-content viewing system shown in FIG. 1.

FIG. 4 is a diagram showing an exemplary structure of table data in a database shown in FIG. 3.

FIG. 5 is a diagram showing an exemplary workflow in the information-content viewing system including the information processing apparatus and the server apparatus.

FIG. 6 is a flowchart showing an example of data processing executed by the information processing apparatus.

FIG. 7 is a diagram showing an exemplary workflow in the information-content viewing system including the information processing apparatus and the server apparatus.

FIG. 8 is a diagram showing an exemplary workflow in the information-content viewing system including the information processing apparatus and the server apparatus.

FIG. 9 is a diagram showing an exemplary workflow in the information-content viewing system including the information processing apparatus and the server apparatus.

FIG. 10 is a flowchart showing an example of data processing executed by the server apparatus.

FIG. 11 is a flowchart showing an example of data processing executed by the server apparatus.

FIG. 12 is a diagram showing examples of various types of data relating to content stored and managed in the database shown in FIG. 3.

FIG. 13 is an illustration showing an example of a Hypertext Markup Language (HTML) document created by the WAS shown in FIG. 1.

FIG. 14 is a flowchart showing an example of data processing executed by the information processing apparatus.

FIG. 15 is a flowchart showing an example of data processing executed by the information processing apparatus.

FIG. 16 is a diagram showing examples of various types of data relating to content stored and managed in the database shown in FIG. 3.

FIG. 17 is a flowchart showing an example of data processing executed by the server apparatus.

FIG. 18 is a diagram showing an example of HTML data generated by the WAS shown in FIG. 1.

FIGS. 19A and 19B are illustrations showing examples of an HTML document distributed from the WAS shown in FIG. 1.

FIG. 20 is a diagram showing examples of various types of data relating to content stored and managed in the database shown in FIG. 3.

FIG. 21 is a flowchart showing an example of data processing executed by the server apparatus.

FIG. 22 is a diagram showing an example of HTML data generated by the WAS shown in FIG. 1.

FIGS. 23A and 23B are illustrations showing examples of an HTML document distributed from the WAS shown in FIG. 1.

FIG. 24 is a diagram showing examples of various types of data relating to content stored and managed in the database shown in FIG. 3.

FIG. 25 is a flowchart showing an example of data processing executed by the server apparatus.

FIG. 26 is a diagram showing an example of HTML data generated by the WAS shown in FIG. 1.

FIGS. 27A and 27B are illustrations showing examples of an HTML document distributed from the WAS shown in FIG. 1.

FIG. 28 is a flowchart showing an example of data processing executed by an information processing apparatus.

FIGS. 29A to 29C are illustrations showing examples of manners of displaying wrapping thumbnails at the information processing apparatus.

FIG. 30 is a flowchart showing an example of data processing executed by the information processing apparatus.

FIGS. 31A and 31B are illustrations showing examples of manners of displaying wrapping thumbnails at the information processing apparatus.

FIG. 32 is a flowchart showing an example of data processing executed by the information processing apparatus.

FIGS. 33A and 33B are illustrations showing examples of manners of displaying wrapping thumbnails at the information processing apparatus.

FIG. 34 is a diagram showing a memory map of a storage medium storing various data processing programs that are readable by the information processing apparatus.

FIG. 35 is a diagram showing a memory map of a storage medium storing various data processing programs that are readable by the server apparatus.

### DESCRIPTION OF THE EMBODIMENTS

Now, embodiments of the present invention will be described with reference to the drawings. The embodiments provide features that allow displaying an attached thumbnail together in a specified manner when a thumbnail found by searching in response to a thumbnail viewing request is displayed.

Description of System Configuration

### First Embodiment

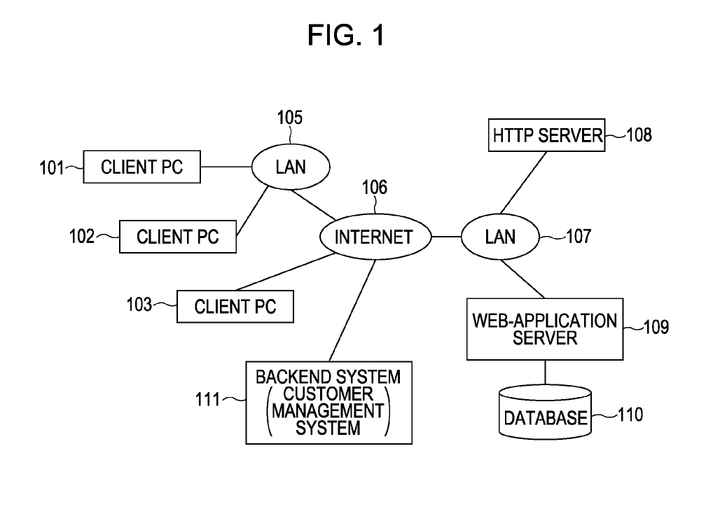

FIG. 1 is a diagram showing the configuration of an information-content viewing system including an information processing apparatus and a thumbnail management apparatus according to a first exemplary embodiment of the present invention. This embodiment will be described in the context of an example where an attached thumbnail is displayed together when a thumbnail of content is displayed.

In the system according to this embodiment, client personal computers (PCs) 101, 102, and 103, an HTTP server (Web server) 108, and a Web-application server (WAS) 109 are provided on a network.

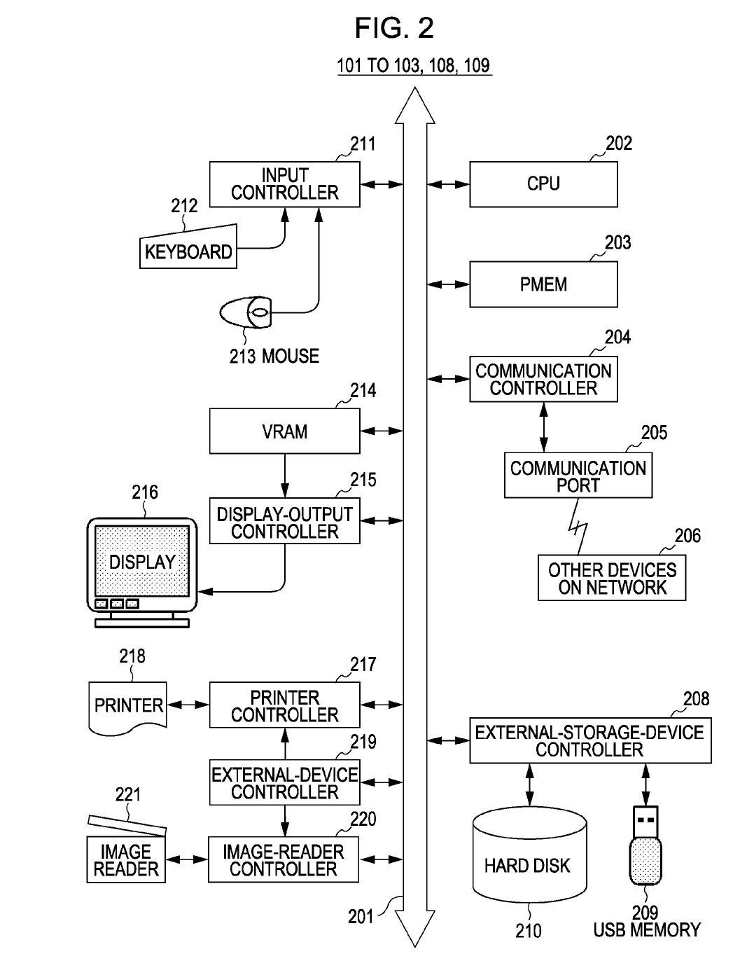

The client PCs 101, 102, and 103 are allowed to carry out communications with the WAS 109 via HTTP using Web browsers. For example, the PCs 101, 102, and 103 are used by a system administrator to do system maintenance tasks, such as maintenance of content or modification of user management information. The hardware configurations of the WAS 109 and the PCs 101 to 103 will be described with reference to FIG. 2.

The network configuration relevant to the system includes local area networks (LANs) 105 and 107 and the Internet 106. The PCs 101 and 102 connected to the LAN 105 exchange data with other apparatuses via the LAN 105. The PC 103 is directly connected to the Internet 106 via a terminal (not shown).

The HTTP server (Web server) 108 receives a request transmitted via HTTP from the PC 101, 102, or 103 via a network. In the HTTP server 108, several WASs are registered. On the basis of the type of the request transmitted from the PC 101, 102, or 103, the HTTP server 108 assigns processing to an appropriate WAS.

The WAS having received a request, for example, the WAS 109, executes processing and returns a result to the PC 101, 102, or 103.

The WAS 109 is connected to a database 110. The database 110 has recorded thereon content data, data associated with content, information such as operation history and processing status, and system information such as user/group information.

In this embodiment, content refers to electronic data that can be handled by an information processing apparatus, such as document data, image data, text data, music data, or video data.

The type of content that is handled differs depending on the type of system that is implemented. For example, in the case of a music distribution system, content that is handled is mainly music files and accompanying document data. In the case of a catalog creating system, content that is handled is mainly image data or text data.

Furthermore, although it is assumed in this embodiment that Web pages are written in HTML, other markup languages or the like may be used to describe Web pages, such as XHTML based on XML. That is, this embodiment is effective regardless of the language used to describe Web pages. Furthermore, the advantage of this embodiment is maintained even when Web pages are generated dynamically.

The HTTP server 108, the WAS 109, and the database 110 are combined organically to constitute the Web database system shown in FIG. 1.

The WAS 109 is connected to a backend system 111 of an enterprise or the like, for example, via the LAN 107, so that content data can be used at the backend system 111. Alternatively, the backend system 111 may be connected directly to the WAS 109.

FIG. 2 is a block diagram showing exemplary configurations of the client PCs 101, 102, and 103, the HTTP server 108, and the WAS 109 shown in FIG. 1.

Referring to FIG. 2, a system bus 201 is connected to a central processing unit (CPU) 202, a program memory (PMEM) 203, and a communication controller 204.

Furthermore, the system bus 201 is connected to an external-storage-device controller 208, an input controller 211, a video image memory (VRAM) 214, and a display-output controller 215. The system bus 201 is also connected to a printer controller 217, an external-device controller 219, and an image-reader controller 220.

The communication controller 204 controls input and output of data through a communication port 205. Signals output through the communication port 205 are transmitted to a communication port of another apparatus 206 on the network via a communication circuit.

The external-storage-device controller 208 controls access to a disk storing data files, such as a universal serial bus (USB) memory 209 or a hard disk (HD) 210.

The input controller 211 is connected to input devices, such as a keyboard 212 and/or a mouse 213. A user can issue operation instructions to the system by operating the input devices.

The video image memory (VRAM) 214 is connected to a display 216 via the display-output controller 215. Data representing an image that is displayed on the display 216 is loaded in the VRAM 214 in the form of bitmap data.

The mouse 213 is a pointing device for issuing instructions for processing image information on the display 216. With the mouse 213, a cursor on the display 216 can be moved arbitrarily in the X and Y directions. Furthermore, with the mouse 213, it is possible to select a command from a command menu or to select an icon to instruct processing or to instruct an item to be edited, a drawing position, or the like.

The PMEM 203 selects and reads a program for executing processing according to this embodiment as needed from the hard disk 210 so that the program can be executed by the CPU 202.

Furthermore, data input from the keyboard 212 is stored as code information in the PMEM 203, which also functions as a text memory. The printer controller 217 controls output of data to a printer 218 connected thereto.

The image-reader controller 220 controls an image reader 221 connected thereto. The external-device controller 219 controls an external device, such as a printer or a scanner.

With the PCs 101, 102, and 103 in this embodiment, the printer 218 and the printer controller 217, and the image-reader controller 220 and the image reader 221, directly connected to the client PC, are not necessarily needed.

Although this embodiment will be described in the context of a network such as a LAN, this embodiment is also applicable to cases where the communication controller 204 is connected to a public circuit via the communication port 205.

Furthermore, functions similar to those in this embodiment can be implemented whether the image-reader controller 220 and the image reader 221 are implemented by physically separate components or the image-reader controller 220 is implemented by a single component including the image reader 221.

Furthermore, the program stored in the PMEM 203 may be stored alternatively in the hard disk (HD) 210 or the USB memory 209 that is connected directly, or in other apparatuses connected via a network.

At each of the PCs 101, 102, and 103, a Web browser (e.g., Microsoft Internet Explorer®) is stored in a storage medium. The CPU 202 reads and executes the Web browser program so that a user interface in this embodiment is provided on the Web browser.

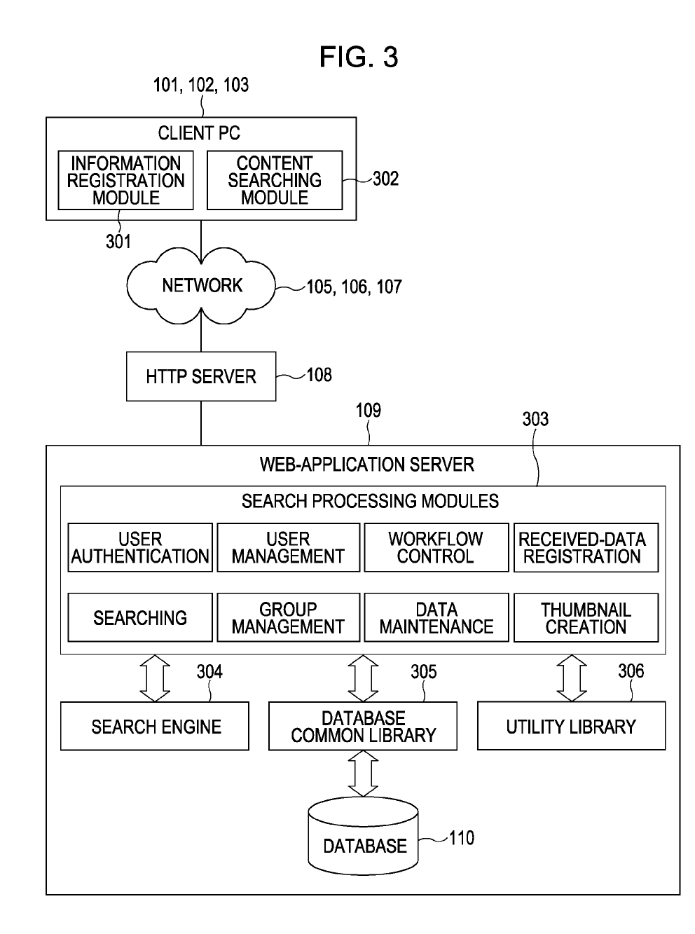

FIG. 3 is a block diagram showing an exemplary module configuration of the information-content viewing system shown in FIG. 1.

As shown in FIG. 3, each of the PCs has stored therein an information registration module 301. The information registration module 301 is used to register content, such as catalog information or image data, to the WAS 109 via the HTTP server 108. The information registration module 301 is also used to register form information for outputting product data (content), which will be described later.

Furthermore, each of the PCs 101, 102, and 103 has stored therein a content searching module 302 used to search for content needed to create the form.

Since these modules are automatically distributed from the WAS 109 as needed, for example, in the form of plug-ins, explicit installation is not needed on the PCs 101, 102, and 103.

Furthermore, the WAS 109 has stored therein search processing modules 303 for processing requests from the PCs 101, 102, and 103, received via the HTTP server 108.

The functions of the search processing modules 303 include, for example, a user authentication function, a user management function, a workflow control function, a received-data registration function, a thumbnail creation function, a group management function, a data maintenance function, and a searching function.

The user authentication function is used for checking the privilege of a user logging into the system. The user management function is used for registration and management of personal information.

The workflow control function is used for controlling workflow. The received-data registration function is used for registration of received form-image data.

The thumbnail creation function is used for creating a thumbnail for displaying registered content. The thumbnail created by the thumbnail creation function of the search processing modules 303 is stored in the database 110 connected to the WAS 109.

The group management function is used for registration and management of groups to which users belong. The data maintenance function is used to set data that is used internally, such as folders for storing data.

The searching function is a function for searching for content registered in the database 110 connected to the WAS 109, or executing full-text searching. These functional modules are loaded as needed in the PMEM 203 according to requests from the PCs 101, 102, and 103, and processing is executed according to the requests.

In addition to the search processing modules 303, the WAS 109 has stored therein a database common library 305 and a utility library 306. The database common library 305 is used for exchanging data with the database 110.

In this embodiment, processing for content searching is executed using a search engine 304. The search engine 304 is located in a layer deeper than a layer of the search processing modules 303.

The relationship of layers described above is only an example, and a search engine and search processing modules may be provided in the same layer, or a search engine may be included in search processing modules.

The search engine 304 is used for searching, such as full-text searching, text searching, or image searching, to find content associated with text data provided as input information. For example, the search engine 304 is capable of returning a list of related sites on the basis of input of keywords or the like relating to products. Thus, by selecting a site from the list, it is possible to access a Web page of the site and to view descriptions of products provided by a manufacturer.

When executing full-text searching or text searching, the search engine 304 may search either specific items included in a document, such as heading and author, or all the information included in a document. The search engine 304 may execute searching in other similar manners.

Furthermore, when executing image searching, the search engine 304 may refer to captions of content or nearby text, or collect in advance data to be used for image searching. The search engine 304 may execute image searching in other similar manners.

In this embodiment, the search engine 304 has a function for finding content associated with input text data, and algorithms and manners of searching may be chosen arbitrarily.

In response to a request from an upper layer, the search engine 304 returns the number of hits and search scores for the individual hits. These pieces of information are obtained by execution of content searching. In this embodiment, search scores are used.

Furthermore, depending on the configuration of the search engine 304, processing may be executed using the database 110.

Furthermore, a plurality of search engines may be used selectively in accordance with the type and purpose of searching.

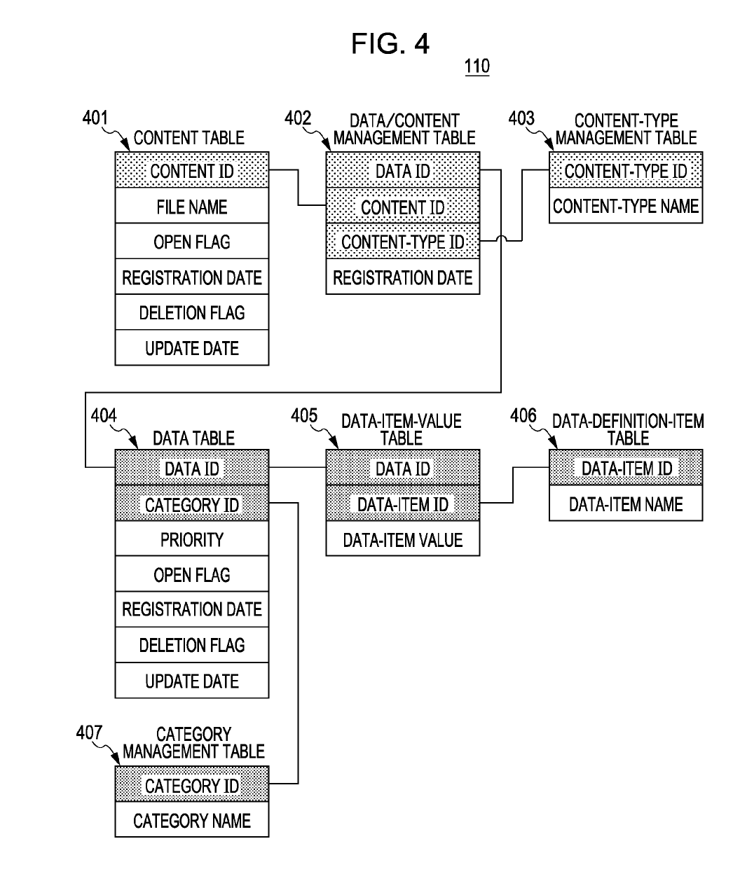

FIG. 4 is a diagram showing an exemplary configuration of table data in the database 110.

In FIG. 4, a data table 404 is used to manage text information, such as product master information. Examples of information recorded in the data table 404 include a uniquely assigned data ID, a category ID, a registration date, an update date, and an open flag indicating whether the information is open on the Web.

Furthermore, the data table 404 includes a deletion flag indicating whether the information has been deleted, and a priority for determining a priority level when a catalog of the product is output.

A category management table 407 is used to manage which data belongs to which category. The category management table 407 includes a category ID and a category name.

A content table 401 is used to manage information such as image files that can be used in catalogs. Similarly to the data table 404, information recorded in the content table 401 includes a uniquely assigned content ID, a file name, a registration date, and an update date. Furthermore, similarly to the data table 404, information recorded in the content table 401 includes an open flag indicating whether the information is open on the Web, and a deletion flag indicating whether the information has been deleted.

A data/content management table 402 associates content files (image files) managed in the content table 401 with text information managed in the data table 404.

A content-type management table 403 is used to manage content types associated with content. The content-type management table 403 includes a content-type ID and a content-type name.

A data-definition-item table 406 is used to manage names of items in a data-item-value table 405 associated with the data table 404. More specifically, names of items regarding product information, such as product name and price, are managed.

The data-item-value table 405 stores data values, such as a data ID, a data-item ID, and a data-item value.

Now, processing associated with characteristic functions of the information processing apparatus and the server apparatus according to this embodiment will be described in the context of the example system shown in FIG. 3.

The information processing apparatus according to this embodiment corresponds to each of the PCs 101 to 103 shown in FIG. 1, which is allowed to communicate, for example, via HTTP, with the Web-application server 109 that processes a request for viewing a thumbnail registered in the database 110.

Each of the PCs 101 to 103 has a selecting function for selecting display control information specifying a manner of display of an attached thumbnail that is attached when a plurality of thumbnails is displayed. Hereinafter, the attached thumbnail is sometimes referred to as a wrapping thumbnail. The plurality of thumbnails displayed is image data that has been processed to facilitate viewing of content. This will be described later in more detail.

Furthermore, each of the PCs 101 to 103 has a requesting function for issuing a request for registering an attached thumbnail and display control information in association with management information of the attached thumbnail. The processing functions are implemented by execution of the information registration module 301 shown in FIG. 3 by the CPU 202 of each of the PCs 101 to 103.

The selecting function can select a plurality of attached thumbnails for each of a plurality of thumbnails.

Furthermore, the selecting function can select display control information specifying a manner of display of a plurality of attached thumbnails.

That is, in association with a thumbnail of content, for example, it is possible to display a plurality of attached thumbnails based on display control information.

After registration of thumbnails of content, each of the PCs 101 to 103 allowed to communicate with the WAS 109 that processes a request for viewing registered content has the following processing functions.

Each of the PCs 101 to 103 has an issuing function for issuing a request for viewing a thumbnail to the WAS 109, and a first obtaining function for obtaining a first thumbnail from the WAS 109 in response to the thumbnail viewing request issued by the issuing function. The first thumbnail refers to a thumbnail that is generated from content, and a second thumbnail refers to a thumbnail that is attached to the first thumbnail.

Each of the PCs 101 to 103 has a checking function for checking whether the second thumbnail associated with the first thumbnail is registered, by issuing a query to the WAS 109. Furthermore, each of the PCs 101 to 103 has a second obtaining function for obtaining the second thumbnail and display control information set for the second thumbnail when it is determined by the checking function that the second thumbnail is registered.

Furthermore, each of the PCs 101 to 103 has a display controlling function for exercising control so that the second thumbnail obtained by the second obtaining function is displayed in association with the first thumbnail when the first thumbnail obtained by the first obtaining function is displayed. These processing functions are implemented by execution of the content searching module 302 shown in FIG. 3 by the CPU 202 of each of the PCs 101 to 103.

The display controlling function exercises control so that a plurality of attached thumbnails is displayed in association with a thumbnail.

Furthermore, the display controlling function exercises control so that a plurality of second thumbnails is displayed in association with a first thumbnail.

Furthermore, the display controlling function can control the position and size of the second thumbnail displayed in association with the first thumbnail. The thumbnail may be generated from content, such as text, image data, or the like.

The display control information includes information specifying display conditions of the second thumbnail. The display conditions include, for example, display position, display size, display timing, display privilege, and number of times of display.

The WAS 109 that processes thumbnail viewing requests from the PCs 101 to 103 has the following processing functions.

The WAS 109 has an input function for receiving input of display control information specifying a manner of display of an attached thumbnail that is displayed in association with a plurality of thumbnails.

Furthermore, the WAS 109 has a registering function for registering the display control information specifying a manner of display of an attached thumbnail, input by the input function, as content management information that is used when displaying an attached thumbnail in association with each of a plurality of thumbnails. Furthermore, the WAS 109 has an output function for outputting information so that an attached thumbnail is displayed in association with a thumbnail relevant to the request among the plurality of thumbnails.

These processing functions are implemented by execution of the search processing modules 303 and the search engine 304 by the CPU of the WAS 109.

Furthermore, the WAS 109 has a determining function of determining page information when thumbnail viewing requests are received from the PCs 101 to 103, using a thumbnail selected from a plurality of thumbnails, the attached thumbnail, and the display control information. The page includes a description of program code that allows display with a function of a Web browser.

Furthermore, the WAS 109 has a transmitting function of transmitting the page information determined by the determining function to the information processing apparatus.

These functions are implemented by execution of the search processing functions 303 and the search engine 304 by the CPU of the WAS 109.

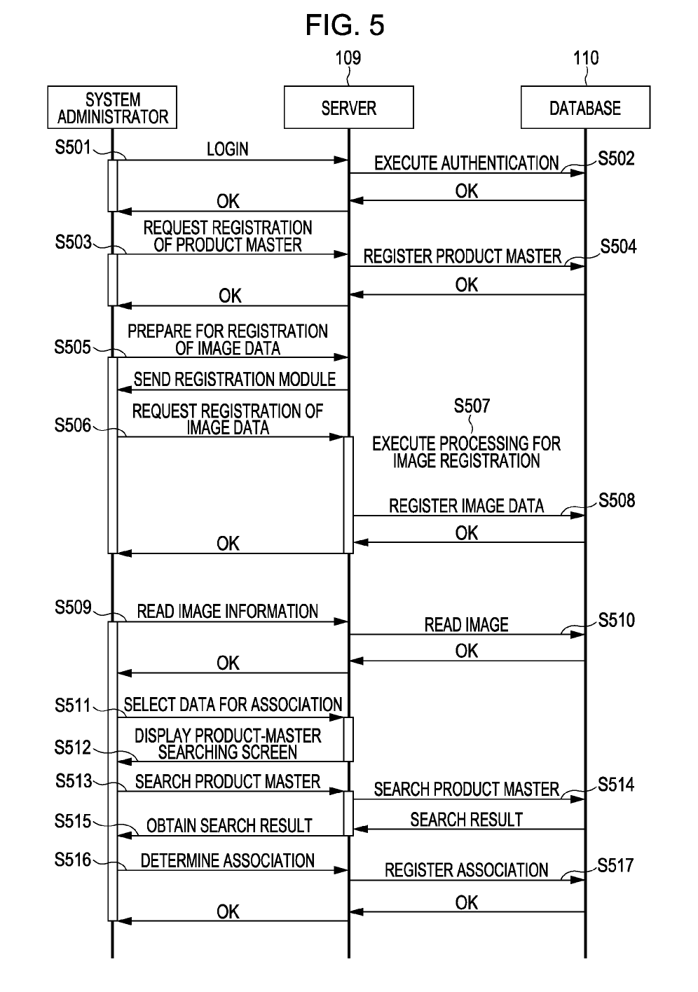

FIG. 5 is a diagram showing an exemplary workflow in the information-content viewing system including the information processing apparatus and the server apparatus. The workflow represents a processing procedure for registering master data and image data in association with each other in a template, the master data being text information regarding product specifications and the image data identifying a product image. Steps S501 to S517 are implemented by the CPU of a client PC operated by a system administrator and the CPU of the WAS 109 loading control programs in the RAMs or the like and executing the programs.

In step S501, the system administrator executes a login procedure to one of the client PCs 101 to 103 shown in FIG. 1, using an account and a password.

The authentication need not be based on an account and a password, and may be executed in other manners.

In response to the request, in step S502, the WAS 109 executes authentication by issuing a query to the database 110 as to whether the account and password of the system administrator that have been input are associated with a user allowed to register master data and images. In the database 110, information needed for user authentication is registered in advance.

When it is determined by the WAS 109 on the basis of the registered authentication information that the system administrator issuing the authentication request is not allowed to register master data and images, an error screen is transmitted to the client PC at the source of the request via HTTP.

On the other hand, when it is determined by the WAS 109 that the system administrator issuing the authentication request is allowed to register master data and images, the procedure proceeds to step S503.

Then, in step S503, a request for registering master data that serves as text information regarding product specifications in the database 110 is issued to the WAS 109.

At the WAS 109, in response to the request from one of the client PCs 101 to 103, in step S504, the master data is registered in the database 110. The master data of a product is text data regarding the product, which can be viewed by the user. The product master data is created using an application, a text editor, or the like (not shown).

This concludes registration of product master data in the database 110. Then, product image data is registered in the database 110. It is possible to successively register two or more pieces of product master data.

In step S505, preparation for registering image data is made to the WAS 109. The WAS 109 transmits a received-data registration module (refer to FIG. 3) that functions as a file registration module to the client PC at the source of the request. At this time, the module is not transmitted when the file registration module is already present on the client PC.

Then, in step S506, the system administrator selects image data to be registered and issues an instruction for registering the image data to the WAS 109, via a user interface screen (not shown) displayed by the Web browser. The image data to be registered may be, for example, image data input from a scanner or the like, or image data generated by an application.

In step S507, the WAS 109, having received the registration request, executes preprocessing for image registration. In this step, the WAS 109 generates a thumbnail of the image data selected for registration. That is, the WAS 109 processes the image data into a size specified in a thumbnail display standard, for example, by decimating the image data.

Then, in step S508, the thumbnail generated by the WAS 109 is transmitted to and registered in the database 110. When the registration of the image data (thumbnail) to the database 110 has been completed normally, the WAS 109 transmits a screen indicating normal completion to the client PC. This concludes registration of the thumbnail for checking the product image in the image data.

Then, processing for associating the product master data and the image data (thumbnail) individually registered in the database 110 is executed.

First, in step S509, a request for reading image data registered in the database 110 is issued to the WAS 109. Upon receiving the request from the client PC operated by the system administrator, in step S510, the WAS 109 reads image data that is not associated with product master data from the database 110, and returns the image data to the client PC via HTTP.

At this time, in some cases, a plurality of pieces of image data is returned to the client PC. In this case, at the client PC operated by the system administrator, the system administrator selects a piece of image data that is to be associated from the plurality of pieces of image data returned from the WAS 109, using the Web browser.

In step S511, an association request is transmitted from the client PC operated by the system administrator to the WAS 109 via HTTP. Then, in step S512, in response to the request, the WAS 109 returns a product-master searching screen to the client PC operated by the system administrator for selection of product master data (text) that is to be associated. Thus, the product-master searching screen is displayed on a display of the client PC operated by the system administrator.

Then, in step S513, searching conditions for master data are reported to the WAS 109. In step S514, the WAS 109 searches the database 110 for master data matching the search conditions. Then, in step S515, the master data obtained by searching the database 110 is transmitted via HTTP to the client PC operated by the system administrator.

In step S516, at the client PC operated by the system administrator, association between the product image data and master data that have been obtained is determined, and the product master data associated with the image data is reported to the WAS 109. Then, in step S517, the associated master data is registered in the database 110.

Thus, it is readily possible to associate image data (thumbnail) regarding a product with master data composed of text data indicating specification information or the like for the image data and to register the image data and master data in the database 110. Thus, it is possible to create associated master data efficiently. Furthermore, it is readily possible to change association between registered master data and thumbnails. This concludes registration of a thumbnail.

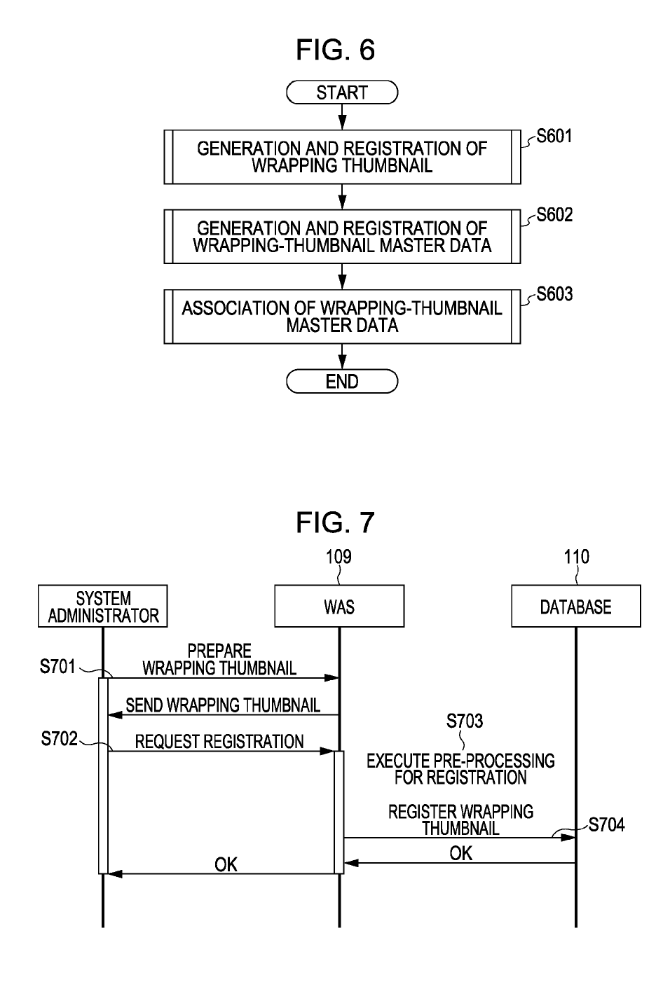

FIG. 6 is a flowchart showing an example of data processing executed by the information processing apparatus. This processing is a detailed example of processing for registering a wrapping thumbnail in the database 110 by the Web application system described with reference to FIGS. 3 to 5. Steps S601 to S603 are implemented by the CPU of the client PC, operated by the system administrator, loading a control program in the RAM and executing the program.

In this embodiment, all the thumbnails (second thumbnails) provided separately from the thumbnails (first thumbnails) corresponding to content are considered. Hereinafter, the thumbnails will be referred to as wrapping thumbnails. Furthermore, although a thumbnail for highlighting a first thumbnail will be refereed to as a second thumbnail, the second thumbnail may be used for purposes other than highlighting. That is, a wrapping thumbnail is a thumbnail that is to be displayed in association with a thumbnail of a product such that the wrapping thumbnail is displayed beside the thumbnail for the product, simultaneously by switching, or alternating. As described above, the wrapping thumbnail may be used for purposes other than highlighting.

This registration procedure has three steps, namely, creation and registration of a wrapping thumbnail, creation and registration of master data for the wrapping thumbnail, and association of the master data for the wrapping thumbnail.

First, in step S601, generation and registration of a wrapping thumbnail is executed from the client PC operated by the system administrator, so that a wrapping thumbnail is generated and registered in the database 110. A detailed flow of step S601 is shown in FIG. 7.

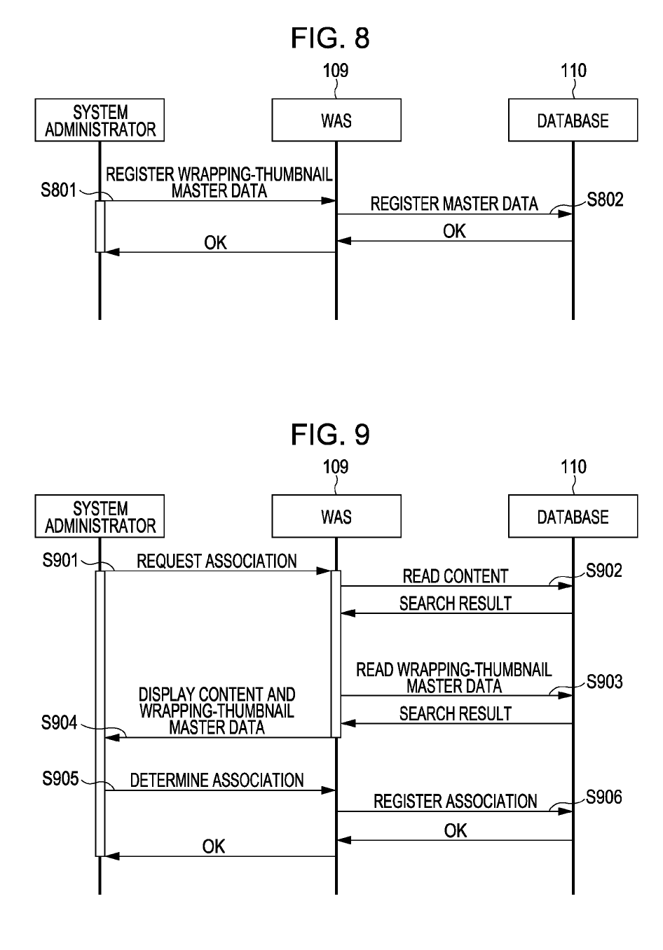

In step S602, master data for the wrapping thumbnail is created and registered. The master data for the wrapping thumbnail refers to a setting value of the wrapping thumbnail that is used. In exemplary embodiments, the master data for the wrapping thumbnail has a format similar to the format of the product master data used in step S503 shown in FIG. 5, although the values and items are different from those in the product master data. Then, the master data for the wrapping thumbnail, generated by the WAS 109, is registered in the database 110. A detailed flow of step S602 is shown in FIG. 8.

Then, in step S603, processing for associating the master data for the wrapping thumbnail with content is executed. This processing is similar to the association executed in step S516 shown in FIG. 5. That is, as opposed to the workflow shown in FIG. 5, which relates to an example of associating product master data with content, in step S603, the master data for the wrapping thumbnail is associated with content. Through this processing, a wrapping thumbnail (and master data for the wrapping thumbnail) for content is determined. A detailed flow of step S603 is shown in FIG. 9.

FIG. 7 shows an exemplary workflow of the information-content viewing system including the information processing apparatus and the server apparatus. This workflow is an example of detailed procedure for generation and registration of a wrapping thumbnail (step S601 in FIG. 6). Steps S701 to S704 are implemented by the CPU of the client PC operated by the system administrator and the CPU of the WAS 109 loading control programs into RAMs and executing the control programs.

First, in step S701, the client PC operated by the system administrator prepares a wrapping thumbnail. The specific method of preparing the wrapping thumbnail is not particularly limited in this embodiment. Furthermore, in this embodiment, the file type of the wrapping thumbnail may be arbitrary, and advantages are not diminished by whatever file type is used.

It is possible to generate original data for the wrapping thumbnail using a specific application, such as drawing application software, and to execute image processing on the original data according to a thumbnail standard.

Alternatively, it is possible to generate original data for the wrapping thumbnail using image application software, for example, from an original-document image obtained by scanning.

Alternatively, the original data for the wrapping thumbnail may be image data captured by a digital camera.

Then, in step S702, one of the client PCs 101 to 103 shown in FIG. 1 (the client PC operated by the system administrator) issues a request for registering the wrapping thumbnail.

In response to the request for registering the wrapping thumbnail from the client PC, in step S703, the WAS 109 executes preprocessing of the wrapping thumbnail. The preprocessing generally refers to image processing that is executed so that the wrapping thumbnail becomes compatible with the system, such as conversion of resolution, size, and extension. It will be appreciated that the preprocessing can be omitted.

After executing the preprocessing as needed, in step S704, the WAS 109 registers the wrapping thumbnail in the database 110. This concludes the processing procedure. In this state, master data for the wrapping thumbnail has not yet been registered. Thus, master data for the wrapping thumbnail is registered in the manner described below.

FIG. 8 shows an exemplary workflow of the information-content viewing system including the information processing apparatus and the server apparatus. This processing is an example of detailed procedure for generation and registration of wrapping-thumbnail master data (step S602 in FIG. 6). Steps S801 to S802 are implemented by the CPU of the WAS 109 loading a control program in the RAM and executing the control program.

First, in step S801, a request for registering wrapping-thumbnail master data is issued to the WAS 109.

The specific method of registration is not particularly limited in this embodiment as long as setting items that are to be defined are properly registered. For example, the wrapping-thumbnail master data may be registered by inputting the wrapping-thumbnail master data using a Web browser or by batch execution of a setting file.

Items that are defined in the wrapping-thumbnail master data include, for example, name of the wrapping thumbnail, display timing, display setting, and privilege. Similarly to the product master, items can be added and deleted as desired through system maintenance.

Then, in step S802, the WAS 109 registers the specified values of the wrapping-thumbnail master data in the database 110. This concludes the processing procedure.

In this state, the wrapping-thumbnail master data and the product master data that have been registered have not yet been associated with each other. Thus, the wrapping-thumbnail master data and the product master data are associated in the manner described below.

FIG. 9 shows an exemplary workflow of the information-content viewing system including the information processing apparatus and the server apparatus according to the first embodiment. This processing is an example of detailed procedure for associating product master data that serves as content with wrapping-thumbnail master data (step S603 of FIG. 6). Steps S901 to S906 are implemented by the CPU of the client PC operated by the system administrator and the CPU of the WAS 109 loading control programs in the RAMs and executing the control programs.

First, in step S901, the system administrator issues an association request from one of the client PCs to the WAS 109 via HTTP. In response to the association request, in step S902, the WAS 109 issues a query for registered content to the database 110. In step S903, the WAS 109 issues a query for registered wrapping-thumbnail master data to the database 110.

Then, in step S904, the client PC operated by the system administrator obtains results of these queries from the WAS 109 via HTTP. Then, the client PC operated by the system administrator displays a Web-browser screen showing the content and the wrapping-thumbnail master data on a display connected to the client PC. The timing and order of steps S902 and S903 described above are only examples, and the timing and order are not limited to the examples.

Then, in step S905, the system administrator specifies wrapping-thumbnail master data that is to be associated with the content from a list displayed in a searching screen on the display via the Web browser, using a mouse or the like, and issues a registration request.

Then, in step S906, when the associated registration request is appropriate, the WAS 109 registers the content relevant to the request and the wrapping-thumbnail master data in association with each other in the database 110. This concludes the processing procedure.

Although not specifically shown in FIG. 9, association between content and wrapping-thumbnail master data may be defined simultaneously for a plurality of sets.

For example, it is possible to associate a plurality of pieces of wrapping-thumbnail master data with a single piece of content, or to associate a single piece of wrapping-thumbnail master data with a plurality of pieces of content. This concludes processing for associated registration of content and wrapping-thumbnail master data.

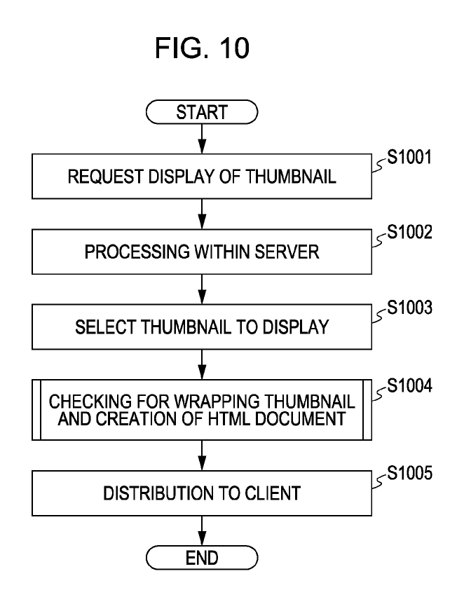

FIG. 10 is a flowchart showing an example of data processing executed by the server. This processing is an example of a procedure for displaying a wrapping thumbnail. Steps S1001 to S1005 are implemented by the CPU of the WAS 109 loading a control program in the RAM and executing the program.

First, in step S1001, the WAS 109 receives a thumbnail displaying request from the client PC operated by the system administrator. This display request is issued, for example, in an operation in which the system administrator searches for content from the client PC or an operation in which the system administrator checks registration status from the client PC.

Without limitation to these examples, the request may be any type of request for displaying a thumbnail for content. Although not particularly limited in this embodiment, the request may be received, for example, by JSP (JavaServer® Pages).

Then, in step S1002, predetermined processing is executed within the WAS 109. Although not particularly limited, the processing may be control of workflow, maintenance of data, or searching by a search engine, executed by the search processing modules 303 shown in FIG. 3.

Then, in step S1003, a thumbnail that is to be displayed is selected. More specifically, since target content is determined in step S1002, a thumbnail that is to be displayed is selected by referring to thumbnail information associated with the content on the basis of association information registered in the database 110.

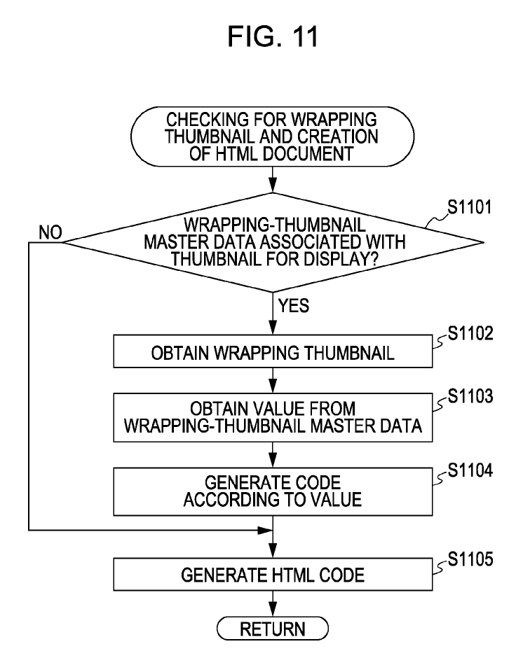

Then, in step S1004, regarding the selected thumbnail, the WAS 109 checks whether a wrapping thumbnail, which is an example of attached thumbnail, is needed, and creates an HTML document that is to be displayed at the client PC. This step is shown in detail in FIG. 11.

Then, in step S1005, the HTML document that has been created is distributed via HTTP to the client PC operated by the system administrator. This concludes the processing procedure.

Thus, a screen including the wrapping thumbnail is displayed via the Web browser at the client PC operated by the system administrator.

FIG. 11 is a flowchart showing an example of data processing executed at the server. This processing is an example of a procedure for checking whether a wrapping thumbnail is to be used and for creating an HTML document, which is called in step S1004 shown in FIG. 10. Steps S1101 to S1105 are implemented by the CPU of the WAS 109 loading a control program in the RAM and executing the control program.

First, in step S1101, the CPU of the WAS 109 checks whether the display thumbnail selected in step S1003 shown in FIG. 10 has been associated with wrapping-thumbnail master data by the procedure shown in FIG. 9, on the basis of association information, which is an example of management information registered in the database 110. When it is determined that wrapping-thumbnail master data has not been associated (NO in step S1101), it is determined that a wrapping thumbnail is not needed. In this case, the procedure proceeds to step S1105.

On the other hand, when it is determined by the CPU of the WAS 109 that wrapping-thumbnail master data has been associated (YES in step S1101), the procedure proceeds to step S1102.

In step S1102, the relevant wrapping thumbnail is obtained from the wrapping-thumbnail master data in the database 110.

Then, in step S1103, information (including display control information) other than the wrapping thumbnail is obtained from the wrapping-thumbnail master data. Then, in step S1104, processing for generating code according to a value set in the display control information obtained in step S1103 is executed. The processing for generating code will be described later. For example, when the number set in the display control information determines the number of times of displaying the wrapping thumbnail, program code for displaying the wrapping thumbnail for the number of times corresponding to the number of times of display is generated. For example, the program code is embedded in an HTML document in the form of JavaScript® code so that the program code is executed at the client PC. The program code may be executed in other manners.

Then, in step S1105, HTML code is generated. The program code generated in step S1104 is embedded to generate an HTML document. This concludes the processing procedure.

The processing flows in the first exemplary embodiment have been described above. Next, examples of data that is used and examples of usage of the data will be described.

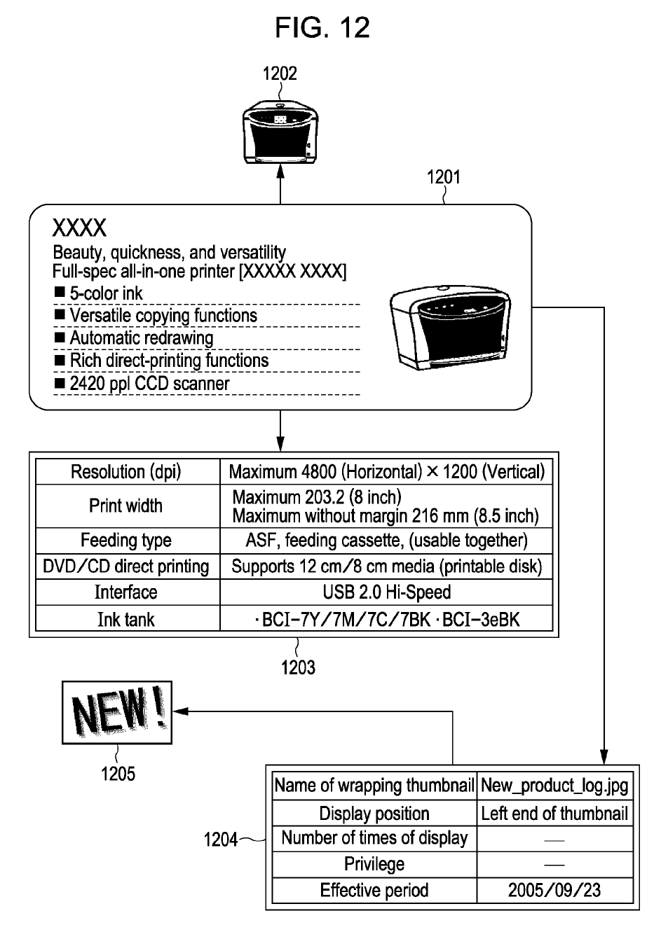

FIG. 12 is a diagram showing examples of various types of data regarding content stored in the database 110 shown in FIG. 3.

Referring to FIG. 12, content 1201 is composed of product master data and image data. The content 1201 includes text data that is based on product master data used in step S505 shown in FIG. 5. The example shown in FIG. 12 is an example in a case of image data representing an external appearance of an ink-jet printer. Other image data may be used depending on the purpose of the content and viewable products.

A thumbnail image 1202 is registered in the database 110 by the WAS 109. The thumbnail 1202 corresponds to the thumbnail generated in step S507 shown in FIG. 5.

The thumbnail 1202 corresponds to the thumbnail selected in step S1003 shown in FIG. 10, i.e., the image included in the HTML document generated.

Product master data 1203 is an example of product master data that is handled in step S503 shown in FIG. 5. In this example, six items regarding the content 1201 are included. However, the number of items and the specific items may be changed as desired.

Wrapping-thumbnail master data 1204 corresponds to data used in step S602 shown in FIG. 6. In this example, five items are included in the wrapping-thumbnail master data 1204. However, the number of items and the specific items may be changed as desired.

Steps S1103 and S1104 shown in FIG. 11 are executed with reference to these values.

A wrapping thumbnail 1205 is placed at a specified display position in the HTML document as a wrapping thumbnail for the product thumbnail 1202. The wrapping thumbnail 1205 and the content 1201 are associated with each other on the basis of the wrapping-thumbnail master data 1204.

More specifically, in this embodiment, the “name of wrapping thumbnail”, which is the first item in the wrapping-thumbnail master data 1204, is referred to, thus identifying a wrapping thumbnail for the content 1201 registered in the database 110.

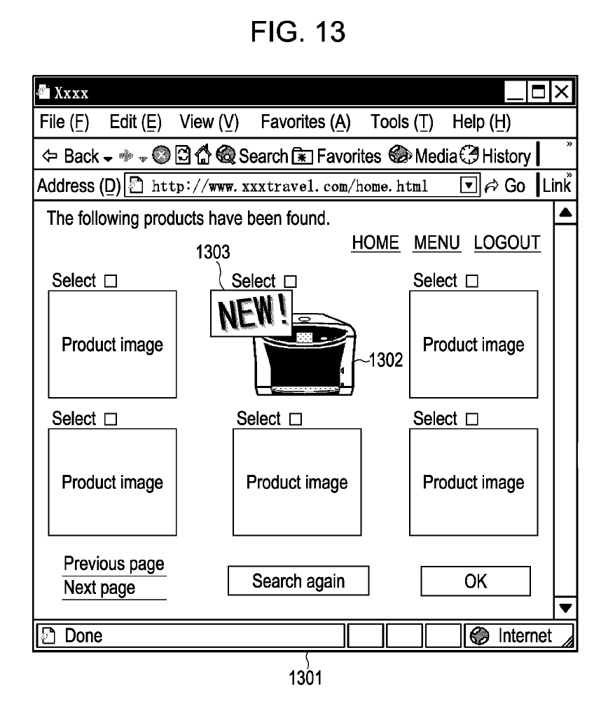

FIG. 13 is a diagram showing an example of the HTML document created by the WAS 109 shown in FIG. 1. The example shows a screen that is displayed using the thumbnail 1202 shown in FIG. 12, via the Web browser on the client PC. As will be described later, the WAS 109 reads data representing the screen from the database 110. Then, the WAS 109 distributes an HTML document generated from the wrapping thumbnail, the product thumbnail, and the display control information to the client PC, and the screen is displayed at the client PC. The display control information differs depending on the manners of display of the wrapping thumbnail. The manners of display of the wrapping thumbnail will be described later.

When a request including relevant data is received in step S1001 shown in FIG. 10, the procedure proceeds to step S1105 shown in FIG. 11. Then, in step S1105, screen data 1301 that can be displayed in the form of an HTML document is created. Then, in step S1005, the screen data 1301 is distributed to and displayed at the client PC, as shown in FIG. 13.

A thumbnail 1302 corresponds to the thumbnail for the content 1201. A wrapping thumbnail 1303 corresponds to the wrapping thumbnail 1205.

In the example shown in FIG. 12, the display position in the wrapping-thumbnail master data 1204 indicates “left end of thumbnail”. Thus, in step S1104, an HTML document reflecting this information is generated. That is, the display layout of the wrapping thumbnail 1303 is determined with reference to the left end of the thumbnail 1302.

It is possible to exercise control so that in association with one thumbnail 1302, a plurality of wrapping thumbnails 1303 of different sizes, for example, a plurality of wrapping thumbnails 1303 similar to each other in shape, is displayed sequentially from smaller to larger.

Furthermore, it is possible to display the wrapping thumbnail 1303 so that the position of the wrapping thumbnail 1303 changes in time along the contour of the thumbnail 1302.

Thus, by simply selecting content, an ordinary user viewing product information at the client PC can display a wrapping thumbnail at a suitable timing as information relating to the product. Since unexpected information is displayed at the same timing as the content of interest, it is readily possible to cause the user to pay attention to the information displayed together with the content.

Furthermore, since the data structure used is different from the data structure used in the animation-based method according to the related art, it suffices to store information representing association between wrapping thumbnails and thumbnails. Thus, as opposed to the related art, storage capacity used in the database 110 is reduced. Furthermore, it is possible to flexibly change or update a wrapping thumbnail that is associated, so that it is possible to display content in combination with wrapping thumbnails with different impressions.

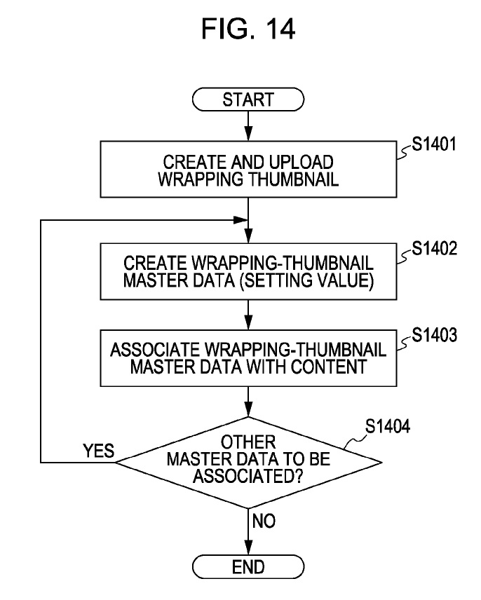

FIG. 14 is a flowchart showing an example of processing executed by the information processing apparatus. This processing corresponds to a procedure for newly adding a wrapping thumbnail in the procedure for processing of a wrapping thumbnail.

Steps S1401 to S1404 are implemented by the CPU of the client PC, operated by the system administrator, executing a control program in the RAM and executing the control program.

In this embodiment, in executing processing, the CPU considers all the thumbnails (second thumbnails) provided separately from thumbnails (first thumbnails) corresponding to content.

In step S1401, on the client PC operated by the system administrator, the CPU executes a specific application, such as an image editing program, to create a wrapping thumbnail on the basis of image data input from a scanner. In this embodiment, the CPU creates pop image data that enhances the impact of the product description.

Then, in step S1402, the CPU creates master data for the wrapping thumbnail, and uploads the master data to the WAS 109 via HTTP. The master data includes display control information that determines a manner of display of the wrapping thumbnail.

The display control information includes, for example, timing information that determines timing of display of the wrapping thumbnail, and control information for controlling an item that is displayed.

Then, in step S1403, the CPU associates the wrapping-thumbnail master data with content registered in the database 110.

Thus, when a request for searching for content registered in the database 110 is received, it is possible to recognize on the basis of content master data that a thumbnail has been set to the content and wrapping-thumbnail master data has been set. Accordingly, when the WAS 109 displays a thumbnail of content on the client PC at the source of the request, a wrapping thumbnail can be displayed in a manner according to the display control information.

In addition to the display control information, user information of a user requesting content may be considered in displaying one or more wrapping thumbnails selected from a plurality of wrapping thumbnails. For example, it is possible to display wrapping thumbnails in different languages depending on whether the displayed information is directed to a user in the United States or a user in Japan.

Then, in step S1404, the CPU checks whether there is any other master data that is to be associated. When it is determined that master data that is to be associated remains (YES in step S1404), the procedure returns to step S1402.

On the other hand, when it is determined in step S1404 that master data that is to be associated does not remain (NO in step S1404), the procedure is exited.

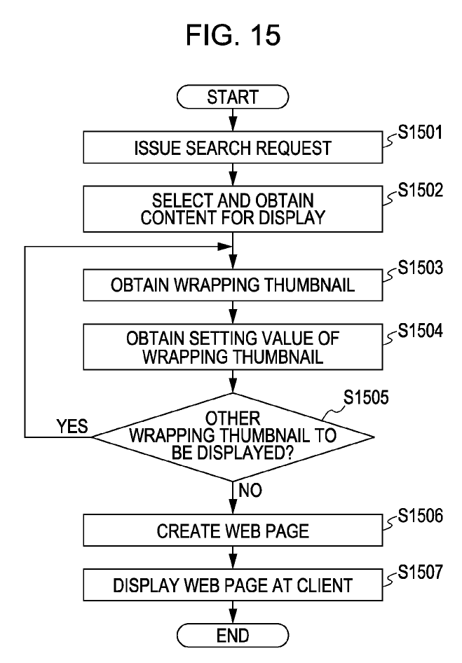

Now, a procedure for displaying content will be described with reference to FIG. 15.

FIG. 15 is a flowchart showing an example of data processing executed by the information processing apparatus. This processing corresponds to a procedure for displaying content by the client PC. Steps S1501 to S1507 are implemented by the CPU of the client PC, operated by the system administrator, loading a control program in the RAM and executing the control program.

In step S1501, the Web browser is activated in order to view content, keywords or the like relating to a site being browsed are input to the search engine, and the CPU issues a searching request to the WAS 109. Then, in step S1502, the CPU obtains an HTML document from the WAS 109 to display content that is to be viewed on the display. Furthermore, in step S1502, after selecting the content displayed, the CPU obtains a thumbnail of the content that is to be viewed.

Then, in step S1503, when a thumbnail is displayed by the Web browser on the client PC, the CPU issues a query to the WAS 109 as to whether a wrapping thumbnail has been registered in association with the content. When a wrapping thumbnail has been registered in association with the content, the CPU obtains the wrapping thumbnail from the WAS 109 via HTTP.

Then, the CPU of the client PC checks whether display control information is set to the master data of the wrapping thumbnail obtained from the WAS 109. When it is determined that display control information is set to the master data of the wrapping thumbnail, in step S1504, the CPU obtains display control information (setting value) set to the master data of the wrapping thumbnail.

Then, in step S1505, the CPU checks whether master data is set to another wrapping thumbnail that is to be displayed. When it is determined that master data is set to another wrapping thumbnail that is to be displayed (YES in step S1505), the procedure returns to step S1503.

On the other hand, when it is determined in step S1505 that master data is not set to another wrapping thumbnail that is to be displayed (NO in step S1505), in step S1506, the CPU creates a Web page that is to be displayed. Then, in step S1507, the CPU of the client PC displays the product thumbnail and the wrapping thumbnail attached to the product thumbnail in a manner according to the display control information on the display via the Web browser. This concludes the procedure.

Hereinabove, the basic functions of the system, namely, a function for registering data, a function for registering a wrapping thumbnail, and a function for generating an HTML document including a wrapping thumbnail in response to a thumbnail displaying request, have been described in the context of the first embodiment.

Furthermore, specific examples of content, product master data, content thumbnails, wrapping-thumbnail master data, and wrapping thumbnails have been described.

According to the first embodiment, by using a wrapping thumbnail, for example, it is readily possible to create an HTML document in which highlighting is added so as to enhance interest in content. Furthermore, it is possible to display content in different manners suitable for different purposes by associating wrapping thumbnails on a content-by-content basis.

### Second Embodiment

In embodiments described below, wrapping thumbnails are displayed in different manners. In the first embodiment described above, wrapping-thumbnail master data is obtained, and an HTML document is created according to a setting value that serves as display control information. As a specific example, processing of a wrapping thumbnail with an effective period will be described below.

The hardware and software configurations in this embodiment are the same as those in the first embodiment unless otherwise explicitly described.

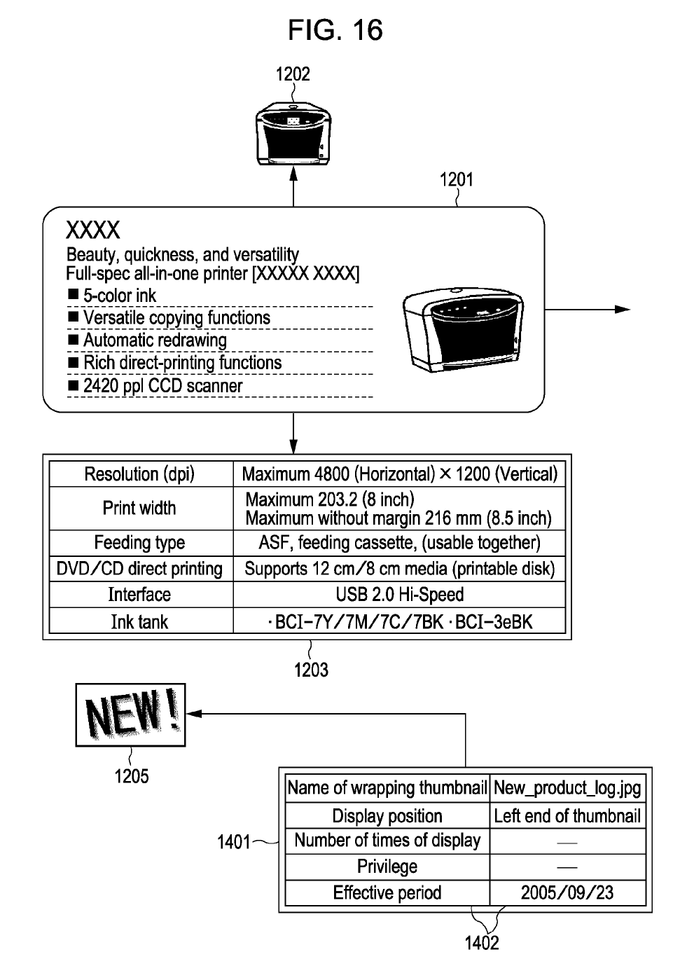

FIG. 16 is a diagram showing examples of various types of data relating to content stored and managed in the database 110 shown in FIG. 3. In FIG. 16, items corresponding to those shown in FIG. 12 are designated by the same numerals, and description thereof will not be repeated.

Referring to FIG. 16, wrapping-thumbnail master data 1401 corresponds to the data 602 shown in FIG. 6. In this embodiment, the value of an “effective period” 1402 is used.

Thumbnail display control information 1402 includes a value “2005/09/23” indicating an effective period for display of the wrapping thumbnail 1205. When the current date exceeds the period, the wrapping thumbnail 1205 is not displayed. This is only an example, and alternatively it is possible to display a wrapping thumbnail constantly after a specified period or to display a wrapping thumbnail during a period from a date A to a date B.

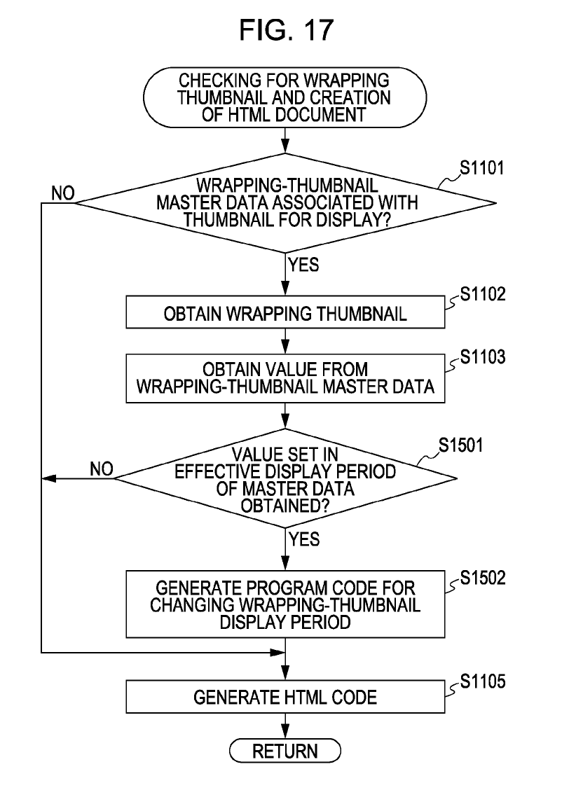

FIG. 17 is a flowchart showing an example of data processing executed by the server apparatus. This processing is an example of a procedure for checking the need for a wrapping thumbnail and creating an HTML document, called in step S1004 shown in FIG. 10. Steps S1101 to S1105 are implemented by the CPU of the WAS 109 loading a control program in the RAM and executing the control program.

Regarding the procedure for checking the need for a wrapping thumbnail and creating an HTML document, description of steps corresponding to those shown in FIG. 11 will not be repeated.

In steps S1101 to S1104 shown in FIG. 17, processing is executed similarly to the corresponding steps shown in FIG. 11 and described above. Then, in steps S1501 and 1502, processing is executed according to a value obtained in step S1103.

First, in step S1501, the CPU of the WAS 109 refers to the value of the display control information 1402 indicating an effective period included in the wrapping-thumbnail master data 1401 shown in FIG. 16.

In the example shown in FIG. 16, a value of “2005/09/23” is set in the master data 1401, so that it is determined that relevant data exists (YES in step S1501). In this case, the procedure proceeds to step S1502.

On the other hand, when it is determined by the CPU of the WAS 109 that relevant data does not exist (NO in step S1501), the procedure proceeds to step S1105.

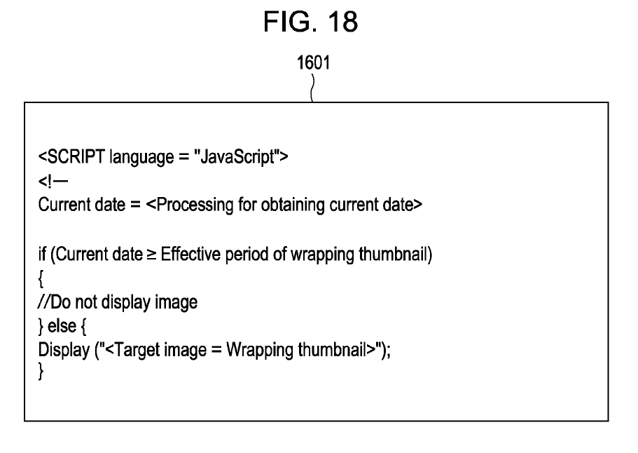

In step S1502, program code that controls display of a wrapping thumbnail on the basis of an effective period is generated. An example of the code is shown in FIG. 18. Then, the CPU of the WAS 109 generates an HTML document reflecting the code.

FIG. 18 is a diagram showing an example of HTML data generated by the WAS 109 shown in FIG. 1. This is an example of program code generated in step S1502 shown in FIG. 17. In this embodiment, it is assumed that the program code is written in JavaScript®. However, the program code may be written in other languages.

According to the code 1601 shown in FIG. 18, first, a current date is obtained. Then, the current date is checked against the effective period according to a conditional expression.

According to the conditional expression, it is checked whether the current date is a date later than the effective period of the wrapping thumbnail. When the current date is a date later than the effective period, the wrapping thumbnail is not displayed.

On the other hand, when the current date is a date earlier than the effective period, processing is executed to display the wrapping thumbnail. In order to make the code more flexible, it is desired to allow changing only the value of the date.

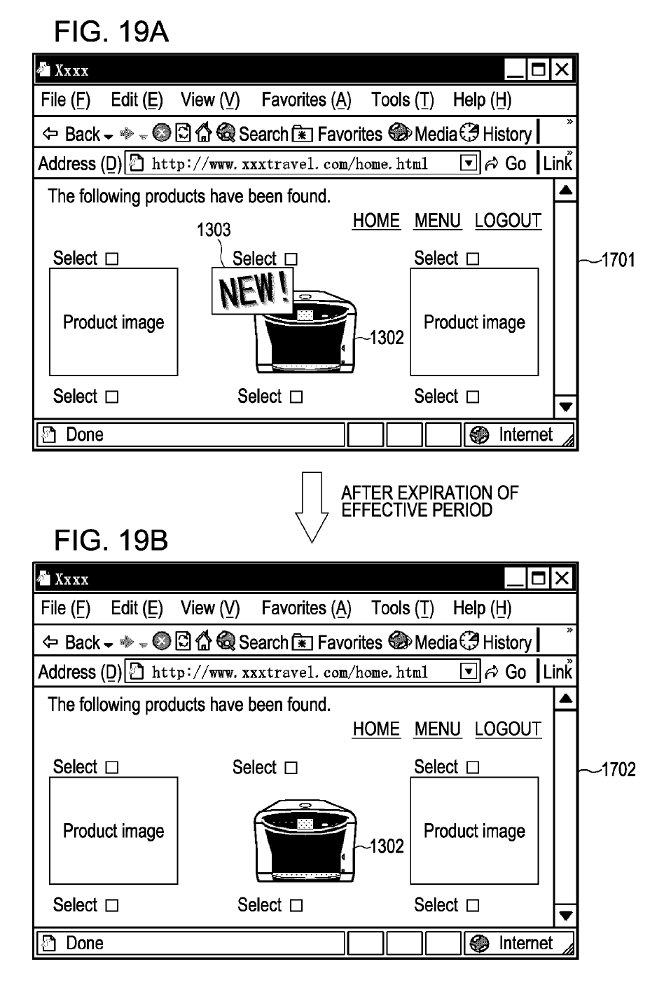

FIGS. 19A and 19B are illustrations showing examples of an HTML document distributed from the WAS 109 shown in FIG. 1 in a case where data shown in FIG. 14 is used.

FIG. 19A shows an example of a screen that is distributed within the effective period, and FIG. 19B shows an example of a screen that is distributed after the expiration of the effective period. In FIGS. 19A and 19B, items corresponding to those shown in FIG. 13 are designated by the same numerals, and description thereof will not be repeated.

Referring to FIG. 19A, a screen 1701 is an example of a screen that is displayed when it is determined that the current date is within the effective period according to the program code shown in FIG. 18. The screen 1701 shows a state where the wrapping thumbnail 1303 is displayed.

Referring to FIG. 19B, a screen 1702 is an example of a screen that is displayed when it is determined that the current date is after the expiration of the effective period. The screen 1702 shows a state where the wrapping thumbnail 1303 is not displayed. As described above, it is possible to vary what is displayed in the same HTML document on the basis of the effective period.

As described above, according to the second embodiment described above, program code is generated and an HTML document is created using wrapping-thumbnail master data.

According to the second embodiment, by generating program code that is based on wrapping-thumbnail master data, it is possible to vary what is displayed in the same HTML document. Thus, it is possible to create an HTML document with dynamic highlighting added.

### Third Embodiment

In the second embodiment described above, an effective period (date) is defined for a wrapping thumbnail. As another example, in a third embodiment described below, a wrapping thumbnail is displayed on the basis of a display period defined for the wrapping thumbnail.

As a specific example, processing of a wrapping thumbnail with an effective display period defined therefor will be described.

The hardware and software configurations in this embodiment are the same as those in the first embodiment unless otherwise explicitly described.

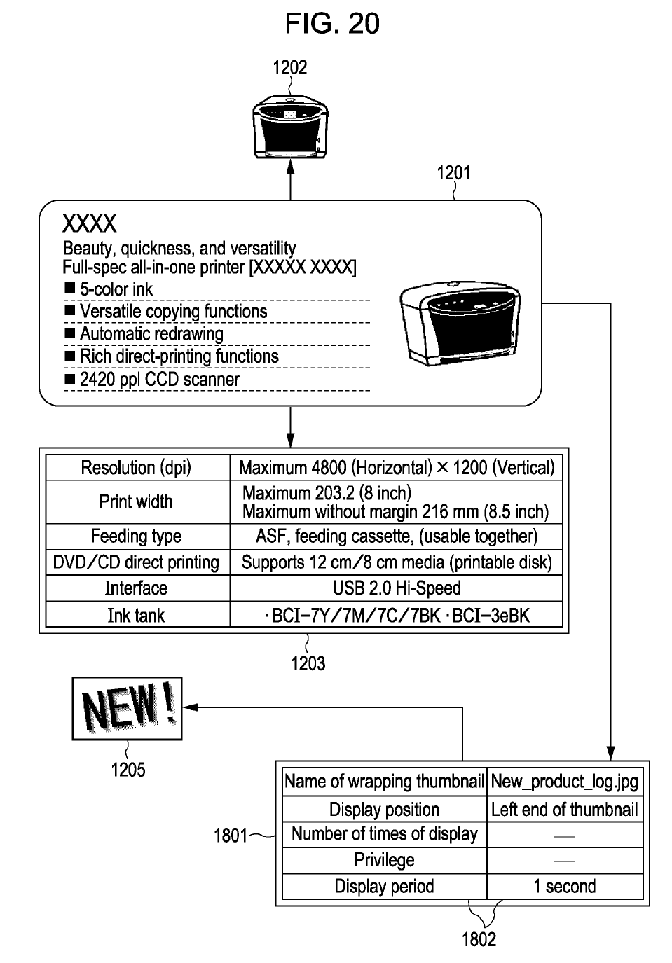

FIG. 20 is a diagram showing examples of various types of data relating to content stored and managed in the database 110 shown in FIG. 3. In FIG. 20, items corresponding to those shown in FIG. 12 are designated by the same numerals, and description thereof will not be repeated.

Referring to FIG. 20, wrapping-thumbnail master data 1801 corresponds to data 602 shown in FIG. 6. The wrapping-thumbnail master data includes an item and value of “display period” 1802.

The display control information 1802 includes a value indicating a display time for the wrapping thumbnail, so that the wrapping thumbnail is displayed only for a period corresponding to the value. The value may be represented in any unit.

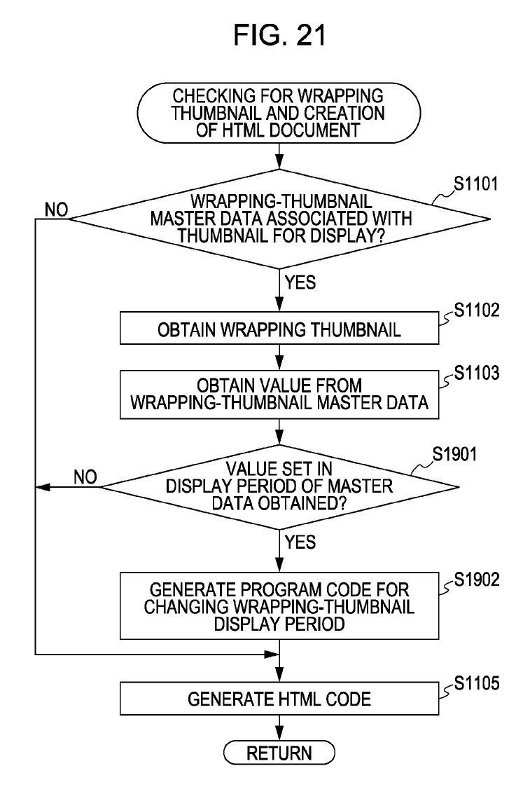

FIG. 21 is a flowchart showing an example of data processing executed by the server. This processing is an example of a procedure for checking the need for a wrapping thumbnail and creating an HTML document, called in step S1004 shown in FIG. 10. Steps S1101 to S1103, S1105, S1901, and S1902 are implemented by the CPU of the WAS 109 loading a control program in the RAM and executing the control program. Regarding the procedure for checking the need for a wrapping thumbnail and creating an HTML document, description of steps corresponding to those shown in FIG. 11 will not be repeated.

In steps S1101 to S1103 shown in FIG. 21, processing is executed similarly to the corresponding steps shown in FIG. 11. Then, in steps S1901 and 1902, processing is executed according to a value obtained in step S1103.

First, in step S1901, the CPU of the WAS 109 refers to the value of the display control information 1802 indicating a display period, included in the wrapping-thumbnail master data 1801 shown in FIG. 20. In this embodiment, a value of “one second” is set in the display control information 1802 indicating a display period included in the wrapping-thumbnail master data 1801, so that it is determined that relevant data exists (YES in step S1901). In this case, the procedure proceeds to step S1902.

On the other hand, when it is determined in step S1901 that a value is not set in the display control information 1802 (NO in step S1901), the procedure proceeds to step S1105.

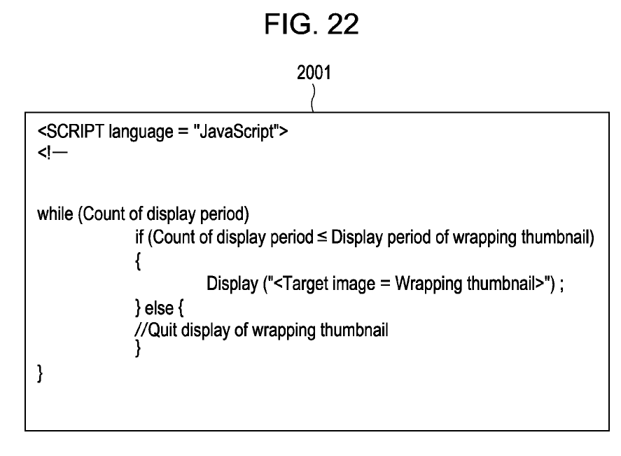

In step S1902, the CPU of the WAS 109 generates program code for controlling display of a wrapping thumbnail on the basis of the display period. An example of the code is shown in FIG. 22. Then, in step S1105, the CPU of the WAS 109 generates HTML data reflecting the code generated.

FIG. 22 is a diagram showing an example of HTML data generated by the WAS 109 shown in FIG. 1. This is an example of program code generated in step S1902 shown in FIG. 21. Although it is assumed in this embodiment that the program code is written in JavaScript®, the program code may be written in other languages.

The program code generated in the procedure shown in FIG. 21 will be described below with reference to FIG. 22.

According to the program code 2001, first, processing is executed to repeatedly count the time elapsed from the start of display of the HTML document.

Then, processing is executed to carry out comparison to check whether the period for which the wrapping thumbnail has been displayed is shorter than the display period set for the wrapping thumbnail.

When it is determined by the CPU of the WAS 109 that the period for which the wrapping thumbnail has been displayed is shorter than the display period set for the wrapping thumbnail, the program code proceeds to processing for displaying the wrapping thumbnail 1205 shown in FIG. 8. The display of the wrapping thumbnail 1205 is stopped when the value set for the wrapping thumbnail 1205 is exceeded.

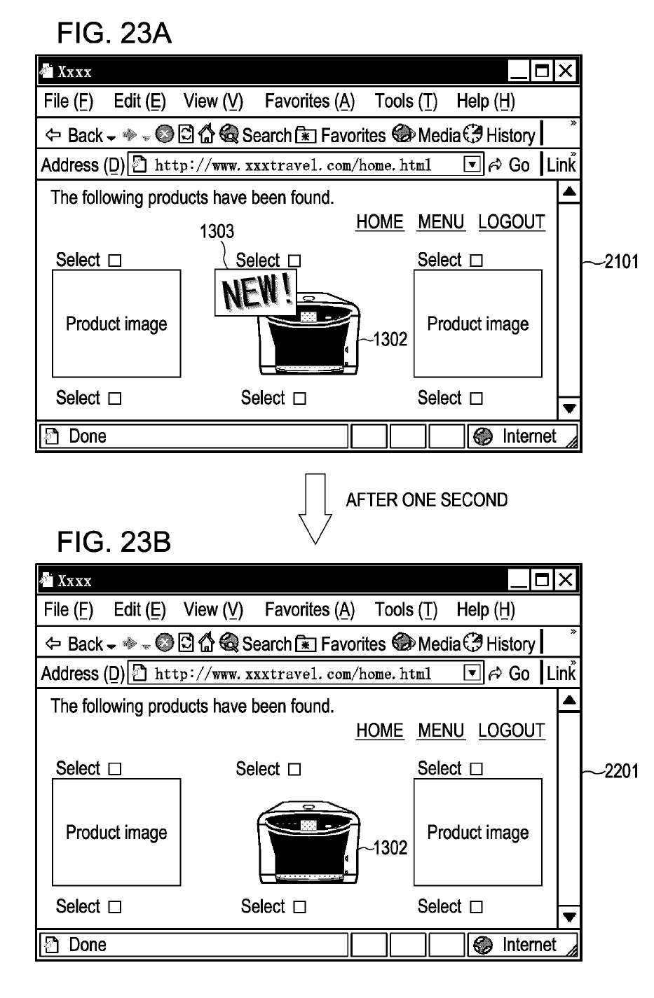

FIGS. 23A and 23B are illustrations showing examples of an HTML document distributed from the WAS 109 shown in FIG. 1 in a case where data shown in FIG. 20 is used.

FIG. 23A shows an example of a screen that is displayed within the effective display period, and FIG. 23B shows an example of a screen that is displayed after the expiration of the effective display period. In FIGS. 23A and 23B, items corresponding to those shown in FIGS. 19A and 19B are designated by the same numerals, and description thereof will not be repeated.

Referring to FIG. 23A, a screen 2101 is an example of a screen that is displayed when it is determined that the current date/time is within the effective display period according to the program code shown in FIG. 22. The screen 2102 shows a state where the wrapping thumbnail 1303 is displayed during the effective display period.

Referring to FIG. 23B, a screen 2201 shows an example of a screen that is displayed when it is determined that the current date/time is after the expiration of the effective period. In the screen 2201, the wrapping thumbnail 1303 is not displayed. As described above, it is possible to vary what is displayed in the same HTML document on the basis of the effective display period.

As described above, according to the third embodiment described above, program code is generated and an HTML document is created using wrapping-thumbnail master data.

According to the third embodiment, by generating program code that is based on wrapping-thumbnail master data, it is possible to vary what is displayed in the same HTML document. Thus, it is possible to create an HTML document with dynamic highlighting added.

### Fourth Embodiment

In a fourth embodiment described below, display of a wrapping thumbnail is controlled on the basis of the number of times of access by a user.

As a specific example, processing of a wrapping thumbnail for which the number of times of access is defined will be described.

The hardware and software configuration in this embodiment are the same as those in the first embodiment unless otherwise described explicitly.

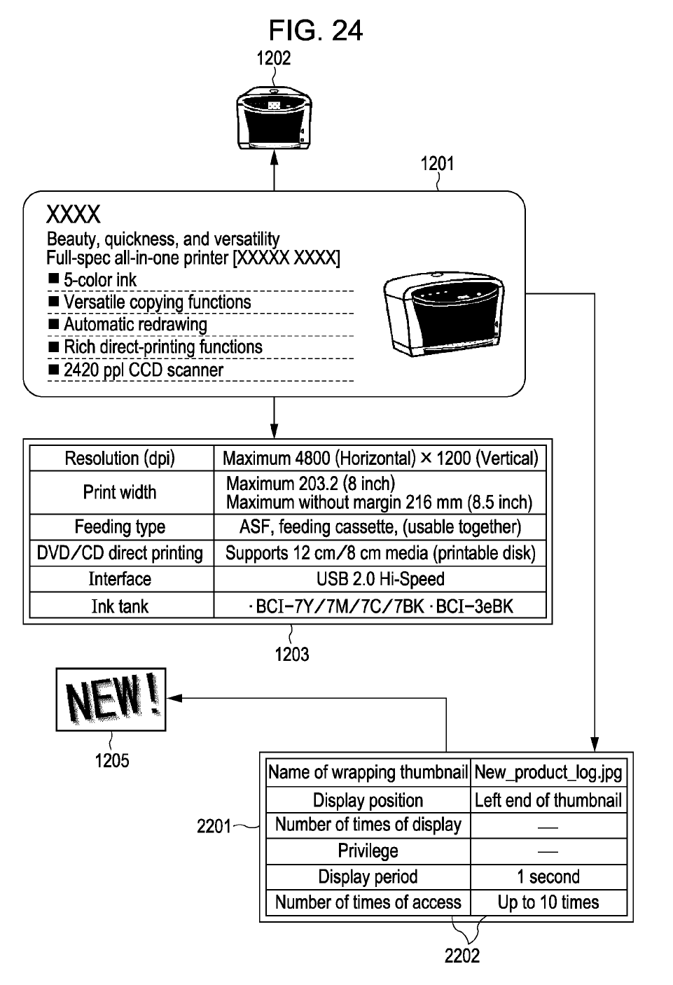

FIG. 24 is a diagram showing examples of various types of data relating to content stored and managed in the database 110 shown in FIG. 3. In FIG. 24, items corresponding to those shown in FIG. 12 are designated by the same numerals, and description thereof will not be repeated.

Referring to FIG. 24, wrapping-thumbnail master data 2201 corresponds to the data 602 shown in FIG. 6. Display control information 2202 includes an item of “number of times of access” having a value defined.

The display control information 2202 includes a value indicating the number of times of access for controlling display of the wrapping thumbnail 1205. The wrapping thumbnail 1205 is displayed only within the number of times of access. Alternatively, the display control information 2202 may be defined so that the wrapping thumbnail 1205 is displayed only after a specific number of times of access.

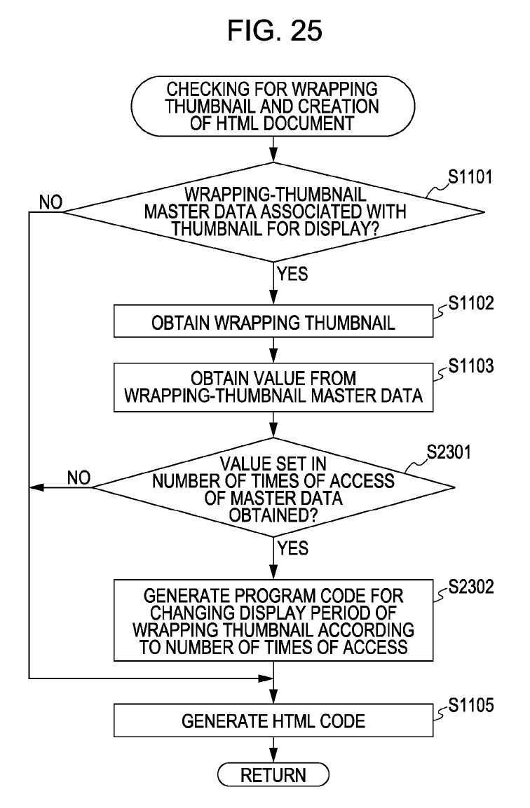

FIG. 25 is a flowchart showing an example of data processing executed by the server apparatus according to this embodiment. This processing is an example of a procedure for checking the need for a wrapping thumbnail and creating an HTML document, called in step S1004 shown in FIG. 10. Steps S1101 to S1103, S1105, S2301, and S2302 are implemented by the CPU of the WAS 109 loading a control program in the RAM and executing the program code. Regarding the procedure for checking the need for a wrapping thumbnail and creating an HTML document, description of steps corresponding to those shown in FIG. 11 will not be repeated.

In steps S1101 to S1103 shown in FIG. 25, processing is executed similarly to the corresponding steps shown in FIG. 11. Then, in steps S2301 and S2302, processing is executed according to a value obtained in step S1103.

First, in step S2301, the CPU of the WAS 109 refers to the value of the display control information 2202 indicating the number of times of access, included in the wrapping-thumbnail master data shown in FIG. 24. In this embodiment, a value of “up to ten times” is set in the display control information 2202, so that it is determined that relevant data exists (YES in step S2301). In this case, the procedure proceeds to step S2302.

On the other hand, when it is determined in step S2301 that a value is not set in the display control information 2202 (NO in step S2302), the procedure proceeds to step S1105.

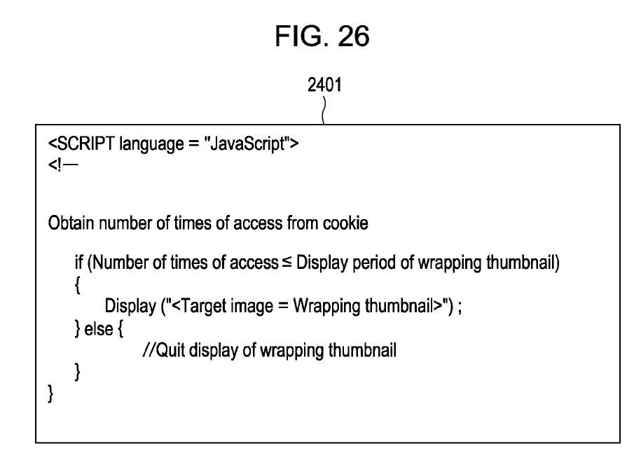

In step S2302, the CPU of the WAS 109 generates program code for controlling display of the wrapping thumbnail 1205 on the basis of the number of times of access. An example of the program code is shown in FIG. 26. Then, in step S1105, the CPU of the WAS 109 generates HTML data reflecting the code, which is to be distributed to the client PC.

FIG. 26 is a diagram showing an example of HTML data generated by the WAS 109 shown in FIG. 1. This is an example of program code generated in step S2302 shown in FIG. 25. Although it is assumed in this embodiment that the program code is written in JavaScript®, the program code may be written in other languages.

The program code generated in the procedure shown in FIG. 25 will be described below with reference to FIG. 26.

According to the program code 2401, first, cookie information of the user is obtained.

Then, from the cookie information obtained, information representing the number of times of access is obtained. A wrapping thumbnail is displayed when the number of times of access is less than the value defined for the wrapping thumbnail.

When the number of times exceeds the value defined for the wrapping thumbnail, the wrapping thumbnail is not displayed.

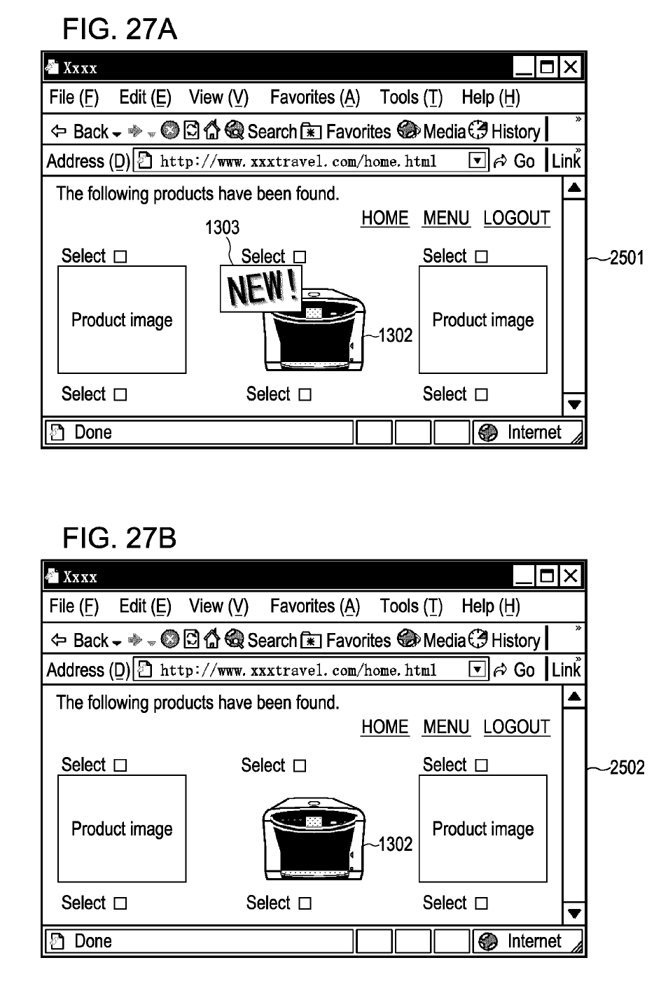

FIGS. 27A and 27B are illustrations showing examples of an HTML document that is distributed from the WAS 109 shown in FIG. 1 in a case where the data representing the number of times of access set in the display control information 2202 shown in FIG. 24 is used.

FIG. 27A shows an example of a screen that is distributed within the number of times of access allowed for effective display, and FIG. 27B shows an example of a screen that is distributed when the number of times of access allowed for effective display is exceeded. In FIGS. 27A and 27B, items corresponding to those shown in FIGS. 19A and 19B are designated by the same numerals, and description thereof will not be repeated.

Referring to FIG. 27A, a screen 2501 is an example of a screen that is displayed when it is determined that the current number of times of access is within the number of times of access allowed for effective display. The screen 2501 shows a state where the wrapping thumbnail 1303 is displayed in association with the thumbnail 1302.

Referring to FIG. 27B, a screen 2502 is an example of a screen that is displayed when the current number of times of access exceeds the defined value. In the screen 2502, the wrapping thumbnail 1303 is not displayed, and the thumbnail 1302 is displayed alone. As described above, it is possible to vary what is displayed in the same HTML document on the basis of the number of times of access.

In the fourth embodiment described above, program code is generated and an HTML document is created using wrapping-thumbnail master data.

According to the fourth embodiment, by generating program code that is based on wrapping-thumbnail master data, it is possible to create an HTML document with dynamic highlighting added.

### Fifth Embodiment

In the embodiments described above, program code is generated so that, in response to a content viewing request from a client PC, an HTML page including a registered wrapping thumbnail is displayed in association with a thumbnail generated at the WAS 109. Hereinafter, processing for displaying wrapping thumbnails in various manners at a client PC in response to a content viewing request from the client PC will be described.

Exemplary Processing for Viewing Content at the Client PC

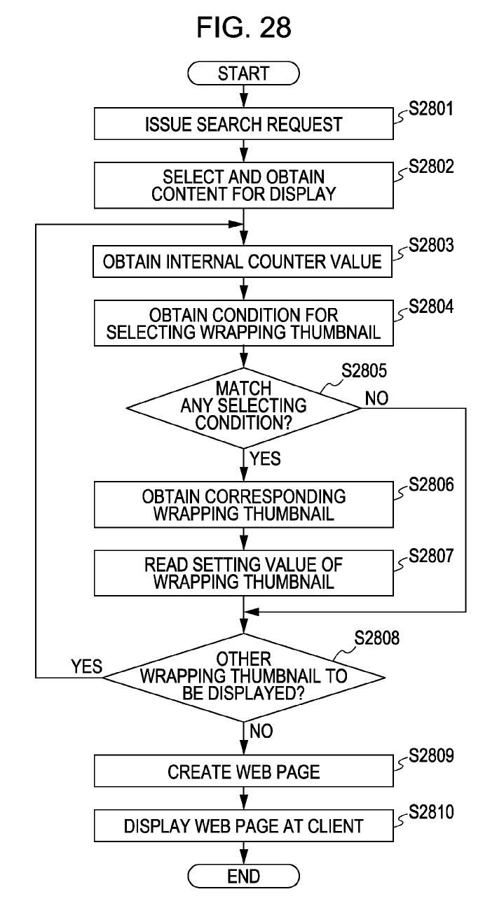

FIG. 28 is a flowchart showing an example of data processing executed by the information processing apparatus. This processing is a procedure for viewing content displayed at a client PC. Steps S2801 to S2810 are implemented by the CPU of the client PC, operated by the system administrator, loading a control program in the RAM and executing the control program.

First, in step S2801, in order to view content, a Web browser is activated, keywords or the like relating to a site being viewed are input to the search engine, and the CPU of the client PC issues a search request to the WAS 109. In step S2802, the CPU of the client PC obtains an HTML document from the WAS 109 to display content that is to be viewed on the display. Furthermore, in step S2802, after the content displayed is selected, the CPU of the client PC obtains a thumbnail of content that is to be viewed.

Then, in step S2803, when the thumbnail is displayed by the Web browser on the client PC, the CPU of the client PC obtains a counter value representing the number of times of viewing the content from the WAS 109. Then, in step S2804, the CPU of the client PC obtains a value representing a selecting condition from the WAS 109, the selecting condition relating to selection of a wrapping thumbnail from a plurality of wrapping thumbnails registered in the database 110.

Then, the CPU of the client PC compares the value of the selecting condition with the counter value (the number of times of access) to determine, for example, whether the counter value is less than or equal to 1,000, between 1,500 and 2,000, or greater than or equal to 2,000. When it is determined by the CPU of the client PC that the number of times of access does not fall in any of these ranges (NO in step S2805), the procedure proceeds to step S2808.

On the other hand, when it is determined in step S2805 by the CPU of the client PC that the number of times of access falls in one of these ranges (YES in step S2805), in step S2806, the CPU of the client PC obtains a wrapping thumbnail that is to be displayed. Then, in step S2807, the CPU of the client PC obtains display control information set for the wrapping thumbnail to be displayed. Then, in step S2808, the CPU of the client PC checks whether there is any other wrapping thumbnail that is to be displayed. When it is determined that there is another wrapping thumbnail that is to be displayed (YES in step S2808), the procedure returns to step S2803.

On the other hand, when it is determined in step S2808 that there is not any other wrapping thumbnail that is to be displayed (NO in step S2808), in step S2809, on the basis of the display control information, the Web browser creates a Web page that is to be displayed. Then, in step S2810, the CPU of the client PC displays the product thumbnail and the wrapping thumbnail attached to the product thumbnail on the display of the client PC via the Web browser, in a manner according to the display control information set for the wrapping thumbnail. This concludes the procedure.

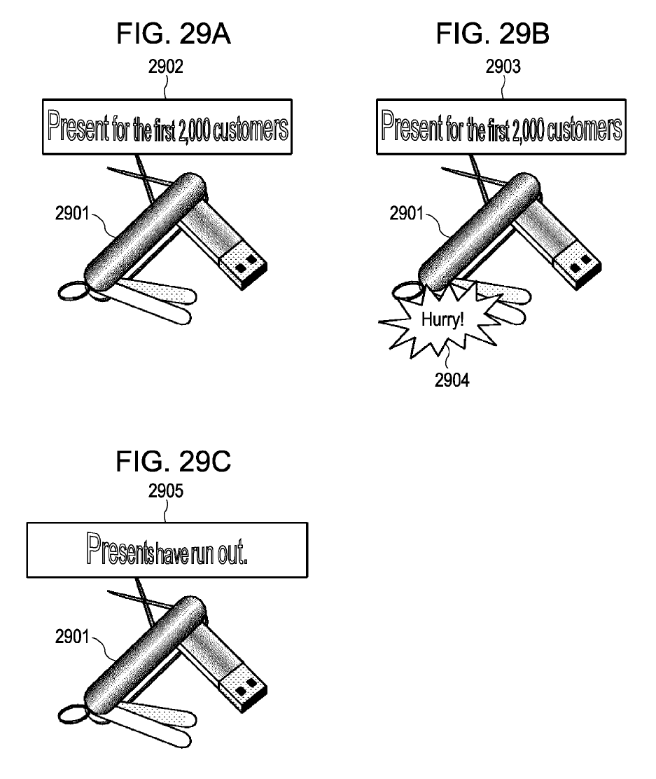

FIGS. 29A to 29C are illustrations showing examples of manners of displaying a wrapping thumbnail at the information processing apparatus.

FIG. 29A shows an example of a manner of displaying a thumbnail 2901 and a wrapping thumbnail 2902 by the Web browser when it is determined in step S2805 shown in FIG. 28 that the number of times of access is less than or equal to a predetermined warning number, e.g., 1500.

FIG. 29B shows an example of a manner of displaying the thumbnail 2901 and wrapping thumbnails 2903 and 2904 by the Web browser when it is determined in step S2805 shown in FIG. 28 that the number of times of access is greater than the predetermined warning number, e.g., 1,500 and less than a predetermined upper limit, e.g., 2,000.

FIG. 29C shows an example of a manner of displaying the thumbnail 2901 and a wrapping thumbnail 2905 by the Web browser when it is determined in step S2805 shown in FIG. 28 that the number of times of access is greater than or equal to the predetermined upper limit, e.g., 2,000.

As described above, in association with the thumbnail 2901, different wrapping thumbnails 2902 to 2905 are displayed on the client PC as the number of times of access to the content requested for viewing changes. That is, it is possible to display different wrapping thumbnails suitably in accordance with the degree of interest in the content (the number of times of access) of the user issuing the viewing request at the client PC.

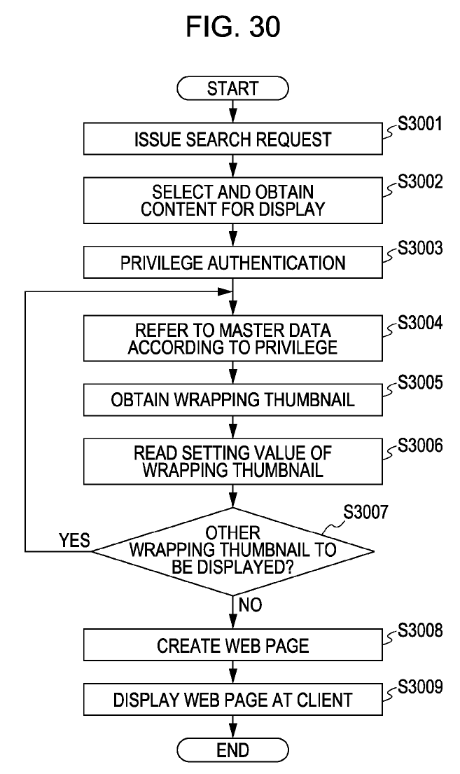

FIG. 30 is a flowchart showing an example of data processing executed by the information processing apparatus. This processing is an example of a procedure for viewing content displayed at a client PC. Steps S3001 to S3009 are implemented by the CPU of the client PC, operated by the system administrator, loading a control program in the RAM and executing the control program.

In this embodiment, it is possible to display different wrapping thumbnails on the basis of viewer privileges associated with individual wrapping thumbnails.

First, in step S3001, in order to view content, a Web browser is activated, and keywords or the like relating to the site being browsed are input to the search engine, and the CPU of the client PC issues a search request to the WAS 109. Then, in step S3002, the CPU of the client PC obtains an HTML document from the WAS 109 to display what is to be viewed on the display. Furthermore, in step S3002, after the displayed content is selected, a thumbnail of content that is to be viewed is obtained.

Then, in step S3003, after information for authentication of viewer privilege is input, a result of authentication of viewer privilege is obtained at the WAS 109. Then, in step S3004, the CPU of the client PC obtains master data of a wrapping thumbnail according to the viewer privilege from the WAS 109.

Then, in step S3005, the CPU of the client PC obtains a wrapping thumbnail identified on the basis of the master data from the WAS 109 via HTTP. Then, in step S3006, the CPU of the client PC obtains display control information set for the wrapping thumbnail that is to be displayed.

Then, in step S3007, the CPU of the client PC checks whether there is any other wrapping thumbnail that is to be displayed. When it is determined that there is any other wrapping thumbnail that is to be displayed (YES in step S3007), the procedure returns to step S3004.

On the other hand, when it is determined in step S3007 that there is not any other wrapping thumbnail that is to be displayed (NO in step S3007), in step S3008, on the basis of the display control information, the Web browser creates a Web page that is to be displayed. Then, in step S3009, the CPU of the client PC displays the product thumbnail and the wrapping thumbnail attached to the product thumbnail on the display via the Web browser in a manner according to the display control information set for the wrapping thumbnail. This concludes the procedure.

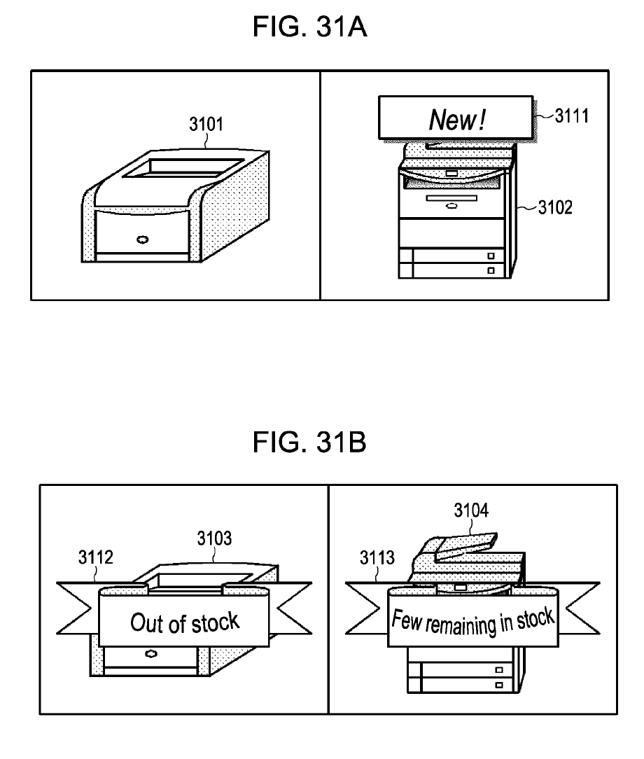

FIGS. 31A and 31B are illustrations showing examples of manners of display of a wrapping thumbnail at the information processing apparatus.

FIG. 31A shows an example of a manner of displaying thumbnails 3101 and 3102 and a wrapping thumbnail 3111 by the Web browser when it is determined by privilege authentication in step S3003 shown in FIG. 29 that the viewer privilege is that of “sales person”. FIG. 31B shows an example of a manner of displaying thumbnails 3103 and 3104 and wrapping thumbnails 3112 and 3113 by the Web browser when it is determined by privilege authentication in step S3003 shown in FIG. 29 that the viewer privilege is that of “inventory manager”.

As described above, in association with the thumbnails 3101 to 3104, different wrapping thumbnails 3111 to 3113 are displayed on the client PC in accordance with difference in access privilege for content requested for viewing. That is, it is possible to display different wrapping thumbnails suitably in accordance with privilege of the user requesting the content from the client PC.

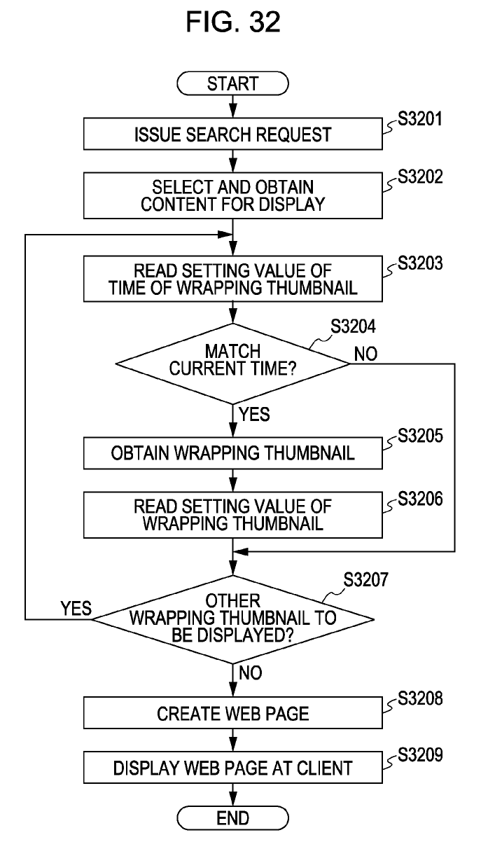

FIG. 32 is a flowchart showing an example of data processing executed by the information processing apparatus. This processing is a procedure for viewing content displayed at a client PC. Steps S3201 to S3209 are implemented by the CPU of the client PC, operated by the system administrator, loading a control program in the RAM and executing the control program.

In this embodiment, it is possible to display different wrapping thumbnails on the basis of association between individual wrapping thumbnails and results of comparison of the current time at the viewer with a time defined by setting.

First, in step S3201, in order to view content, a Web browser is activated, keywords relating to the site being browsed are input to the search engine, and the CPU of the client PC issues a search request to the WAS 109. Then, in step S3202, the CPU of the client PC obtains an HTML document from the WAS 109 to display content that is to be viewed on the display. Furthermore, in step S3202, after the displayed content is selected, the CPU of the client PC obtains a thumbnail for content that is to be viewed.

Then, in step S3203, the CPU of the client PC obtains a time setting value included in the wrapping-thumbnail master data from the WAS 109.

Then, in step S3204, the CPU of the client PC obtains the current time from a real-time clock or the like, and compares the current time with the time setting value to determine whether the current time falls within the defined display period.

When it is determined that the current time does not fall within the defined display period (NO in step S3204), the procedure proceeds to step S3207, in which the CPU of the client PC executes processing to display only the product thumbnail.

On the other hand, when it is determined in step S3204 that the current time falls within the defined display period (YES in step S3204), in step S3205, the CPU of the client PC obtains a wrapping thumbnail identified on the basis of the master data from the WAS 109 via HTTP. Then, in step S3206, the CPU of the client PC obtains display control information (setting value) set for the wrapping thumbnail that is to be displayed.

In step S3207, the CPU of the client PC checks whether there is any other wrapping thumbnail that is to be displayed. When it is determined that there is another wrapping thumbnail that is to be displayed (YES in step S3207), the procedure returns to step S3203.

On the other hand, when it is determined in step S3207 that there is not any other wrapping thumbnail that is to be displayed (NO in step S3207), in step S3208, on the basis of the display control information, the Web browser creates a Web page that is to be displayed. Then, in step S3209, the CPU of the client PC displays the product thumbnail and the wrapping thumbnail attached to the product thumbnail on the display via the Web browser, in a manner according to the display control information set for the wrapping thumbnail. This concludes the procedure.

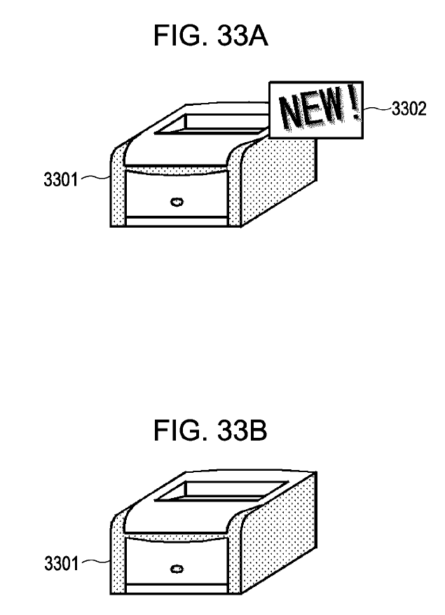

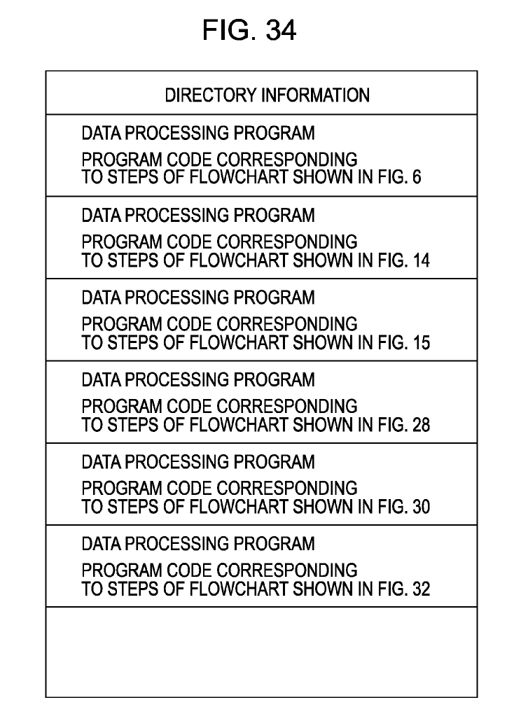

FIGS. 33A and 33B are illustrations showing examples of a manner of displaying a wrapping thumbnail at the information processing apparatus.

FIG. 33A shows an example of manner of displaying a thumbnail 3301 and a wrapping thumbnail 3302 by the Web browser when it is determined in step S3204 shown in FIG. 32 that the current time falls within the defined display period. FIG. 33B shows an example of manner of displaying only the thumbnail 3301 by the Web browser when it is determined in step S3204 shown in FIG. 32 that the current time does not fall within the defined display period.

As described above, in association with the thumbnail 3301, the wrapping thumbnail 3302 is displayed on the client PC on the basis of the result of comparison of the current time with the defined display period for the content being requested for viewing. That is, it is possible to display different thumbnails suitably in accordance with the time of issuance of a viewing request from the client PC.

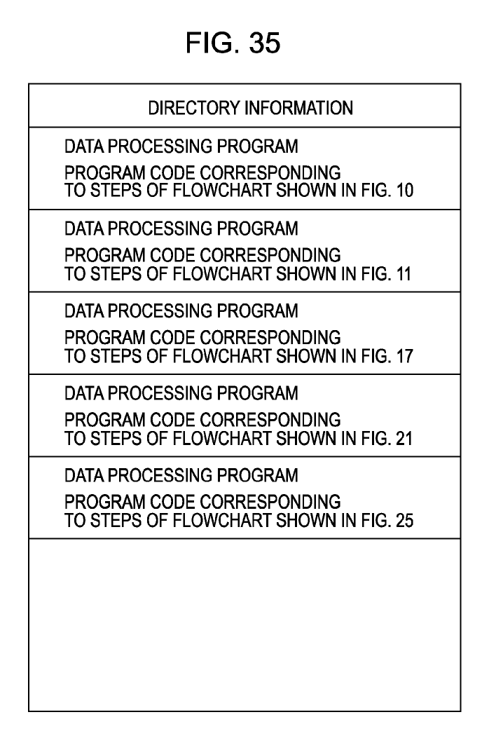

Now, examples of data processing programs readable by the information processing apparatus and the server apparatus according to this embodiment will be described with reference to a memory map shown in FIGS. 34 and 35.

FIG. 34 is a diagram showing a memory map of a storage medium storing various data processing programs readable by the information processing apparatus.

FIG. 35 is a diagram showing a memory map of a storage medium storing various data processing programs readable by the server apparatus.

Although not shown specifically, information for managing a set of programs stored on the storage medium, such as version information and author information, may also be stored. Furthermore, information that depends on an operating system (OS) or the like that reads the programs, such as icons or the like for representing the programs, may also be stored.

Furthermore, data belonging to various programs are managed in directories. Furthermore, a program for installing various programs on a computer, a program for decompressing compressed programs that are to be installed, and the like may also be stored.

The functions shown in FIGS. 6, 10, 11, 14, 15, 17, 21, 25, 28, 30, and 32 according to the embodiments may be executed by a host computer according to programs installed from outside. In this case, information including the program may be supplied to an output device using a storage medium such as a CD-ROM, a flash memory, or a floppy disk, or from an external storage medium via a network. The embodiments can also be implemented in this manner.

As described above, it is possible to supply a system or apparatus with a storage medium storing program code of software implementing the functions of the embodiments described above so that a computer (or a CPU or an MPU) of the system or apparatus reads and executes the program code stored in the storage medium.

In this case, the novel functions of the present invention are implemented by the program code itself, read from the storage medium.

Thus, the types of the programs do not matter as long as the programs function properly, such as object code, programs executed by interpreters, or script data supplied to an OS.

The storage medium for supplying the programs may be, for example, a flexible disk, a hard disk, an optical disk, a magneto-optical disk, a CD-ROM, a CD-R, a CD-RW, a magnetic tape, a non-volatile memory card, a ROM, or a DVD.

In this case, the functions of the embodiments described above are implemented by the program code itself, read from the storage medium, so that the storage medium storing the program code falls within the scope of the present invention.

The programs may be supplied in other manners. For example, the programs may be obtained by connecting to an Internet Web page using a browser on a client computer, and downloading the computer programs or a compressed file thereof including an automatic installation function from the Web page to a recording medium such as a hard disk. Furthermore, it is possible to divide program code of the programs according to the embodiments into a plurality of files so that the files can be downloaded individually from different Web pages. That is, WWW serves or FTP servers may be used to allow a plurality of users to download program files for implementing the functions of the embodiments using computers.

Furthermore, the programs according to the embodiments may be encrypted and stored on a storage medium, such as a CD-ROM, for distribution to a user. In this case, a user who satisfies a predetermined condition is allowed to download key information for decryption from a Web page via the Internet, so that the user can decrypt the encrypted program using the key information and install the program on a computer.

Furthermore, instead of a computer reading and executing program code to achieve the functions of the embodiments described above, the functions of the embodiments may be achieved by an operating system (OS) or the like running on the computer, executing actual processing in part or in entirety according to the program code.

Furthermore, program code read from a recording medium may be written to a memory of a function extending board or a function extending unit connected to the computer so that a CPU or the like of the function extending board or the function extending unit executes actual processing in part or in entirety according to the program code, thus achieving the functions of the embodiments described above.

According to the embodiments described above, when a thumbnail found by searching is displayed in response to a thumbnail viewing request, it is possible to display an attached thumbnail associated with the thumbnail.

Furthermore, it is possible by simple operations to change an attached thumbnail associated with a registered thumbnail to a different thumbnail, or to cancel association of an attached thumbnail.

Thus, it is possible to flexibly deal with requests for changing or adding an attached thumbnail.

Furthermore, since it is possible to associate a registered attached thumbnail with other content, attached thumbnails can be used more generally, so that the use of efficiency of attached thumbnails is improved.

Thus, a storage area needed to store attached thumbnails can be reduced. Accordingly, the load of management of thumbnails is reduced.

Furthermore, since the manner of displaying an attached thumbnail can be defined flexibly by setting display control information, for example, it is readily possible to highlight only a particular thumbnail as desired.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2006-100197 filed Mar. 31, 2006, which is hereby incorporated by reference herein in its entirety.

What is claimed is:

1. An information processing apparatus that carries out communications with a server apparatus that processes a request for viewing a registered thumbnail, the information processing apparatus comprising:
a selecting unit configured to select display control information specifying a manner of display of at least one attached thumbnail attached to display of at least one thumbnail; and
a requesting unit configured to issue a registration request to the server apparatus, the registration request requesting that the at least one attached thumbnail and the display control information be registered in association with management information of the at least one thumbnail.

2. The information processing apparatus according to claim 1, wherein the display information includes information specifying a display condition of the at least one attached thumbnail.

3. The information processing apparatus according to claim 2, wherein the display condition of the at least one attached thumbnail includes at least one of a display position, a display size, a display timing, a display privilege, and a number of times of display.

4. The information processing apparatus according to claim 1, wherein content that serves as a source of the at least one thumbnail includes at least one of text data and image data.

5. An information processing apparatus that carries out communications with a server apparatus that processes a request for viewing a registered thumbnail, the information processing apparatus comprising:
an issuing unit configured to issue a thumbnail viewing request to the server apparatus;
a first obtaining unit configured to obtain a first thumbnail in response to the thumbnail viewing request from the issuing unit;
a checking unit configured to issue a query to the server apparatus to check whether a second thumbnail associated with the first thumbnail is registered;
a second obtaining unit configured to obtain the second thumbnail and display control information set for the second thumbnail when it is determined by the checking unit that the second thumbnail is registered; and
a display controlling unit configured to control display so that, when the first thumbnail obtained by the first obtaining unit is displayed, the second thumbnail obtained by the second obtaining unit is displayed in association with the first thumbnail based on the display control information.

6. The information processing apparatus according to claim 5, wherein the display controlling unit is configured to control display so that a plurality of second thumbnails is displayed in association with the first thumbnail.

7. The information processing apparatus according to claim 5, wherein the display controlling unit is configured to control display so that a display position and a display size of the second thumbnail are associated with the first thumbnail.

8. The information processing apparatus according to claim 5, wherein the display control information includes information specifying a display condition of the second thumbnail.

9. The information processing apparatus according to claim 8, wherein the display condition of the second thumbnail includes at least one of a display position, a display size, a display timing, a display privilege, and a number of times of display.

10. A thumbnail management apparatus that processes a thumbnail viewing request from an information processing apparatus, the thumbnail management apparatus comprising:
an input unit configured to receive input of display control information specifying a manner of display of at least one attached thumbnail that is displayed in association with at least one thumbnail;
a registration unit configured to register the display control information specifying the manner of display of the at least one attached thumbnail, input via the input unit, as management information that is used when the at least one attached thumbnail is displayed in association with the at least one thumbnail; and
an output unit configured to output information for displaying the at least one attached thumbnail in association with a requested thumbnail among the at least one thumbnail, using the management information registered by the registration unit.

11. The thumbnail management apparatus according to claim 10, further comprising:
a determining unit configured to determine page information in response to the thumbnail viewing request from the information processing apparatus, using a thumbnail selected by the information processing apparatus from the at least one thumbnail, the at least one attached thumbnail, and the display control information; and
a transmitting unit configured to transmit the page information determined by the determining unit to the information processing apparatus.

12. The thumbnail management apparatus according to claim 10, wherein the display control information includes information specifying a display condition of the at least one attached thumbnail.

13. The thumbnail management apparatus according to claim 11, wherein the display condition of the at least one attached thumbnail includes at least one of a display position, a display size, a display timing, a display privilege, and a number of times of display.

14. A content processing method for an information processing apparatus that carries out communications with a server apparatus that processes a request for viewing a registered thumbnail, the content processing method comprising:
selecting, at the information processing apparatus, display control information specifying a manner of display of at least one attached thumbnail attached to display of at least one thumbnail; and
issuing a registration request from the information processing apparatus to the server apparatus, the registration request requesting that the at least one attached thumbnail and the display control information be registered in association with management information of the at least one thumbnail.

15. The content processing method according to claim 14, wherein the display information includes information specifying a display condition of the at least one attached thumbnail.

16. The content processing method according to claim 15, wherein the display condition of the at least one attached thumbnail includes at least one of a display position, a display size, a display timing, a display privilege, and a number of times of display.

17. The content processing method according to claim 14, wherein content that serves as a source of the at least one thumbnail includes at least one of text data and image data.

18. A computer-readable storage medium storing a program for allowing a computer to execute the content processing method according to claim 14.

19. A content processing method for an information processing apparatus that carries out communications with a server apparatus that processes a request for viewing a registered thumbnail, the content processing method comprising:
issuing a thumbnail viewing request from the information processing apparatus to the server apparatus;
obtaining, at the information processing apparatus, a first thumbnail in response to the thumbnail viewing request;
issuing a query from the information processing apparatus to the server apparatus to check whether a second thumbnail associated with the first thumbnail is registered;
obtaining, at the information processing apparatus, the second thumbnail and display control information set for the second thumbnail when it is determined that the second thumbnail is registered; and
controlling display so that, when the first thumbnail is displayed, the second thumbnail is displayed in association with the first thumbnail based on the display control information.

20. The content processing method according to claim 19, wherein display is controlled so that a plurality of second thumbnails is displayed in association with the first thumbnail.

21. The content processing method according to claim 19, wherein display is controlled so that at least one of a display position and a display size of the second thumbnail is associated with the first thumbnail.

22. The content processing method according to claim 19, wherein the display control information includes information specifying a display condition of the second thumbnail.

23. The content processing method according to claim 22, wherein the display condition of the second thumbnail includes at least one of a display position, a display size, a display timing, a display privilege, and a number of times of display.

24. A computer-readable storage medium storing a program for allowing a computer to execute the content processing method according to claim 19.

25. A content processing method for a thumbnail management apparatus that processes a thumbnail viewing request from an information processing apparatus, the content processing method comprising:
receiving input of display control information specifying a manner of display of at least one attached thumbnail that is displayed in association with at least one thumbnail;
registering the display control information specifying the manner of display of the at least one attached thumbnail, as management information that is used when the at least one attached thumbnail is displayed in association with the at least one thumbnail; and
outputting information for displaying the at least one attached thumbnail in association with a requested thumbnail among the at least one thumbnail, using the management information.

26. The content processing method according to claim 25, further comprising:
determining page information in response to the thumbnail viewing request from the information processing apparatus, using a thumbnail selected by the information processing apparatus from the at least one thumbnail, the at least one attached thumbnail, and the display control information; and
transmitting the page information to the information processing apparatus.

27. The content processing method according to claim 25, wherein the display control information includes information specifying a display condition of the at least one attached thumbnail.

28. The content processing method according to claim 27, wherein the display condition of the at least one attached thumbnail includes at least one of a display position, a display size, a display timing, a display privilege, and a number of times of display.

29. A computer-readable storage medium storing a program for allowing a computer to execute the content processing method according to claim 25.
